(19) United States
(12) Patent Application Publication
(10) Pub. No.: US 2025/0266955 A1
(43) Pub. Date: Aug. 21, 2025

(54) METHODS AND APPARATUS FOR SUPPORTING LOCATION ASSISTED INITIAL ACCESS

(71) Applicant: InterDigital Patent Holdings, Inc., Wilmington, DE (US)

(72) Inventors: Jaya Rao, Montreal (CA); Fumihiro Hasegawa, Westmount (CA); Tuong Hoang, Montreal (CA); Dylan Watts, Montreal (CA); Moon IL Lee, Melville, NY (US); Oumer Teyeb, Montreal (CA); Paul Marinier, Brossard (CA); Aata El Hamss, Laval (CA)

(73) Assignee: InterDigital Patent Holdings, Inc., Wilmington, DE (US)

(21) Appl. No.: 18/854,192

(22) PCT Filed: Apr. 4, 2023
(86) PCT No.: PCT/US2023/017406

§ 371 Date: Oct. 4, 2024

Related U.S. Application Data
(60) Provisional application No. 63/327,219, filed on Apr. 4, 2022.

(51) Int. Cl. H04L 5/00; H04W 64/00; H04W 74/0833

(52) U.S. Cl. CPC H04L 5/0051; H04L 5/0055; H04W 64/00; H04W 74/0833

(57) ABSTRACT

The disclosure pertains to methods and apparatus for network verification of a Wireless Transmit/Receive Unit (WTRU)'s geographic location upon initial access of the WTRU to the network. For example, the WTRU is configured to receive configuration information indicating a first set of resources for initial access transmissions and a second set of resources for sounding reference signal for positioning (SRSp) transmissions; transmit a first initial access transmission comprising a random access preamble associated with the first set of resources and first information indicating one or more resources from the second set of resources; transmit a first SRSp transmission using the one or more resources from the second set of resources; receive a second initial access transmission comprising second information indicating a first status for the first initial access transmission and a second status for the first SRSp transmission; and transmit, based on the second information, an uplink transmission.

### CROSS-REFERENCE TO RELATED APPLICATION(S)

This application claims priority to and the benefit of U.S. Provisional Application No. 63/327,219 filed in the U.S. Patent and Trademark Office on Apr. 4, 2022, the entire contents of which being incorporated herein by reference as if fully set forth below in its entirety and for all applicable purposes.

### SUMMARY

The present disclosure is generally directed to the fields of wireless communications networks. For example, one or more embodiments disclosed herein are related to methods, apparatuses, systems, and/or procedures for network verification of a Wireless Transmit/Receive Unit (WTRU)'s geographic location upon initial access of the WTRU to a wireless network (e.g., a 5G New Radio (NR) network).

In one embodiment, a method implemented by a wireless transmit/receive unit (WTRU) for wireless communications includes receiving configuration information indicating a first set of resources for initial access transmissions and a second set of resources for sounding reference signal for positioning (SRSp) transmissions; transmitting a first initial access transmission comprising a random access preamble associated with the first set of resources and first information indicating one or more resources from the second set of resources; transmitting a first SRSp transmission using the one or more resources from the second set of resources; receiving a second initial access transmission comprising second information indicating a first status for the first initial access transmission and a second status for the first SRSp transmission; and transmitting, based on the second information, an uplink transmission.

In one embodiment, a WTRU comprising a processor, a receiver, a transmitter, and memory is configured to implement one or more methods disclosed herein. For example, the WTRU comprising circuitry, including a transmitter, a receiver, a processor, and memory, is configured to receive configuration information indicating a first set of resources for initial access transmissions and a second set of resources for sounding reference signal for positioning (SRSp) transmissions; transmit a first initial access transmission comprising a random access preamble associated with the first set of resources and first information indicating one or more resources from the second set of resources; transmit a first SRSp transmission using the one or more resources from the second set of resources; receive a second initial access transmission comprising second information indicating a first status for the first initial access transmission and a second status for the first SRSp transmission; and transmit, based on the second information, an uplink transmission.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a series of four signal flow diagrams illustrating four different types of random access procedure in 5G networks;

FIG. 3 is graphical illustration of random access channel (RACH) occasions in 5G;

FIG. 4 is a graphical illustration of RACH occasions in which a WTRU requests positioning during initial access by transmitting sounding reference signal (SRS) for positioning (SRSp) in one or more RACH occasions used for preamble repetitions in accordance with an embodiment;

FIG. 5 is a flowchart illustrating WTRU operation to transmit SRSp based on reception of initial access messages in accordance with an embodiment;

FIG. 6 is a graphical illustration of a collision-free occasion of random access and positioning transmissions in accordance with an embodiment;

FIG. 7 is a graphical illustration of a collision occasion of positioning transmissions in accordance with an embodiment;

FIG. 8 is a graphical illustration of a collision occasion of random access (e.g., MsgA collision) transmissions in accordance with an embodiment;

FIG. 9 is a flowchart illustrating a first example operation of performing random access and positioning transmissions in accordance with an embodiment; and

FIG. 10 is a flowchart illustrating a second example operation of performing random access and positioning transmissions in accordance with an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### 1 EXAMPLE COMMUNICATION SYSTEMS AND DEVICES

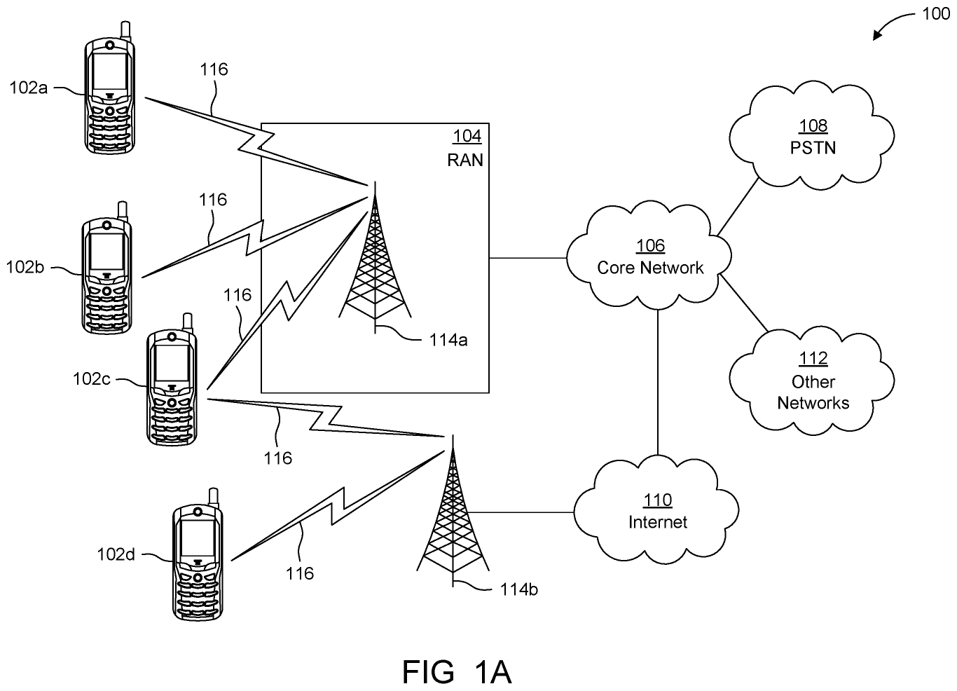

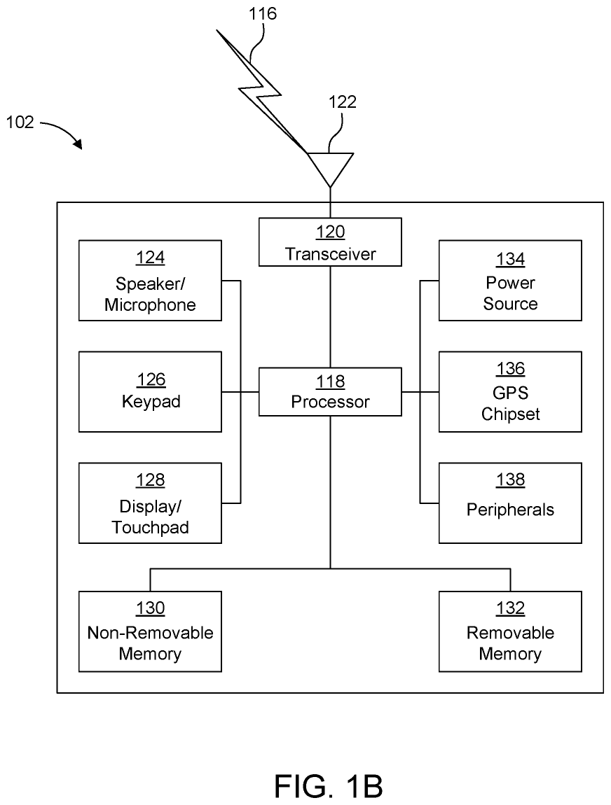

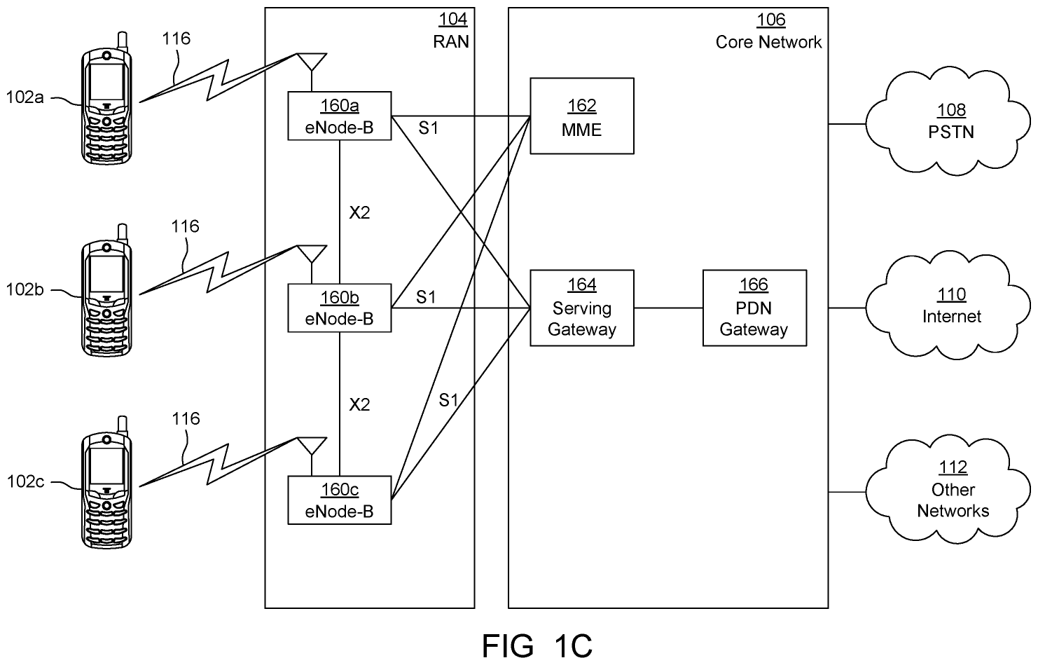

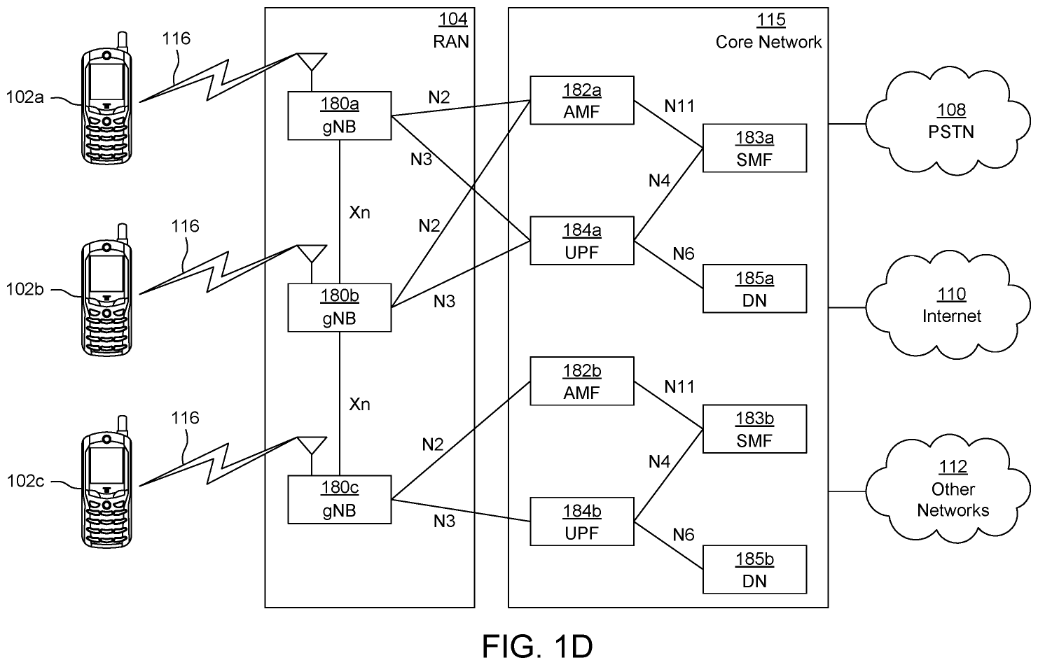

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 1041113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11 ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Packet Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### 2 POSITIONING IN 5G

In Rel. 16 and Rel-17, downlink, uplink and downlink and uplink positioning methods are all available for use.

In the downlink positioning methods, Positioning Reference Signals (PRS) from multiple TRPs are received by the WTRU. The WTRU will observe multiple PRSs and measure the time difference of arrival between a pair of PRSs. Then, the WTRU sends the measured Received Signal Time Difference (RSTD) to the Location Management Function (LMF). In addition, the WTRU can send measured RSRP for each PRS. Based on the returned measurements, the LMF conducts positioning of the WTRU. Alternatively, the WTRU can report RSRP for downlink (DL) angle-based positioning methods.

An LMF is a non-limiting example of a node or entity (e.g., network node or entity) that may be used for or to support positioning. Any other node or entity may be substituted for the LMF and still be consistent with this disclosure.

In the uplink positioning methods, the WTRU sends Sounding Reference Signals (SRS) for positioning, configured by Radio Resource Control (RRC), to Reception Points (RPs). For timing-based methods, a Transmission/Reception Point (TRP) measures Relative Time of Arrival (RTOA) for received SRS and reports the measured values to the LMF. WTRU can report RSRP for SRS. In the angle-based uplink positioning methods, RP will measure angles of arrival and report to the LMF.

Finally, in the uplink and downlink positioning method, the WTRU measures Rx-Tx time difference between received PRS and SRS transmitted. The Rx-Tx time difference is reported to the LMF from the WTRU. The WTRU can also report measured Reference Signal Received Power (RSRP) for PRS. Similarly, at the TRP, Rx-Tx difference between received SRS and transmitted PRS is computed.

In this disclosure, the following positioning methods may be considered.

A “DL positioning method”, which may refer to any positioning method that uses downlink reference signals, such as PRS. In these types of methods, the WTRU receives multiple reference signals from a TP and measures DL RSTD and/or RSRP. Examples of DL positioning methods include DL-AoD (Angle of Departure) and DL-TDOA positioning.

A “UL positioning method”, which may refer to any positioning method that uses uplink reference signals, such as SRS, for positioning. in these types of methods, the WTRU transmits SRS to multiple RPs and the RPs measure the UL RTOA and/or RSRP. Examples of UL positioning methods include Uplink Time Difference of Arrival (UL-TDoA) and Uplink Angle of Arrival (UL-AoA) positioning.

A “DL & UL positioning method”, which may refer to any positioning method that use both uplink and downlink reference signals for positioning. In one example, a WTRU transmits SRS to multiple TRPs and the gNB measures Rx-Tx time difference. The gNB may measure RSRP for the received SRS. The WTRU measures Rx-Tx time difference for PRS transmitted from multiple TRPs. The WTRU can measure RSRP for the received PRS. The Rx-TX difference and possibly RSRP measured at the WTRU and gNB are used to compute round trip time. Here, Rx and Tx difference refers to the difference between arrival time of the reference signal transmitted by the TRP and transmission time of the reference signal transmitted from the WTRU. An example of DL & UL positioning method is multi-RTT (Round Trip Time) positioning.

In this disclosure, the term “Network” may refer to any of the Access and Mobility control Function (AMF), Location Management Function (LMF), base station, TRP, or gNB in NG-RAN (Next Generation-Radio Access Technology Network).

Rel-16/Rel-17 positioning procedures for DL-PRS measurements in RRC CONNECTED allow a limited level of intra-gNB mobility (within coverage areas of TRPs belonging to the same gNB) and inter-gNB mobility (for scenarios where the same PRS configuration is used by multiple gNBs). The reporting of measurements or location information to the LMF is supported via the serving gNB/cell.

### Overview of Initial Access Procedures

In this disclosure, the terms “initial access” and “random access” are used interchangeably to refer to the one or more procedures associated with establishing connectivity between the WTRU and the network. The following provides the background on random access procedures in NR as described in TS 38.300.

The random access procedure may be triggered by any of the following events: initial access from RRC IDLE; RRC Connection Re-establishment procedure; DL or UL data arrival during RRC_CONNECTED when UL synchronisation status is “non-synchronised”; UL data arrival during RRC_CONNECTED when there are no Physical Uplink Control Channel (PUCCH) resources for Scheduling Request (SR) available; SR failure; request by RRC upon synchronous reconfiguration (e.g., handover); RRC Connection Resume procedure from RRC_INACTIVE; to establish time alignment for a secondary TAG; request for other System Information (SI); beam failure recovery; and/or consistent UL Listen Before Talk (LBT) failure on SpCell.

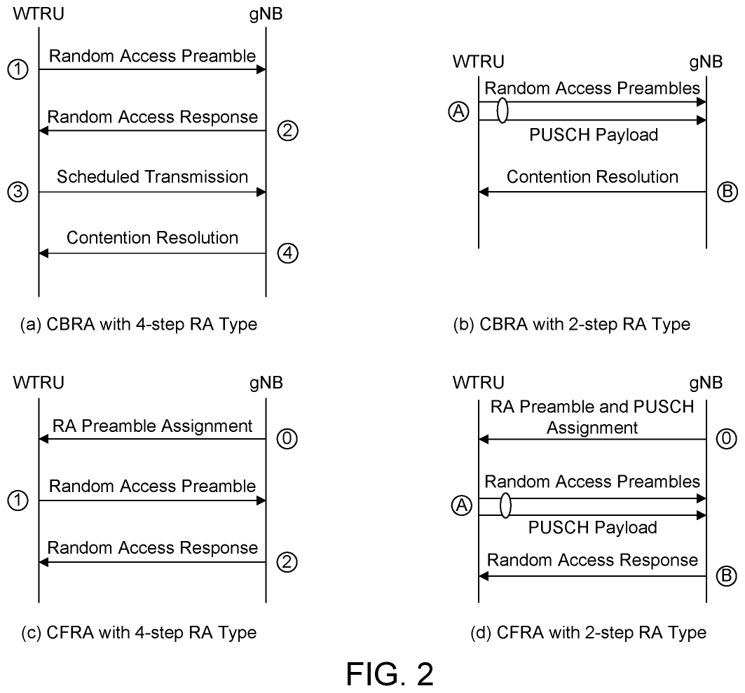

Two types of random access (RA) procedure are supported: 4-step RA type with MSG1 and 2-step RA type with MSGA. Both types of RA procedure support contention-based random access (CBRA) and contention-free random access (CFRA), as shown in FIG. 2. Examples of different types of initial access are illustrated in FIG. 2.

The WTRU selects the type of random access at initiation of the random access procedure based on network configuration: when CFRA resources are not configured, an RSRP threshold is used by the WTRU to select between 2-step RA type and 4-step RA type; when CFRA resources for 4-step RA type are configured, the WTRU performs random access with 4-step RA type; when CFRA resources for 2-step RA type are configured, the WTRU performs random access with 2-step RA type.

The network does not configure CFRA resources for 4-step and 2-step RA types at the same time for a Bandwidth Part (BWP). CFRA with 2-step RA type is only supported for handover.

The MSG1 of the 4-step RA type comprises a preamble on Physical Random Access Channel (PRACH). After MSG1 transmission, the WTRU monitors for a response from the network within a configured window. For CFRA, a dedicated preamble for MSG1 transmission is assigned by the network and, upon receiving random access response from the network, the WTRU ends the random access procedure as shown in part c of FIG. 2. For CBRA, upon reception of the random access response, the WTRU sends MSG3 using the UL grant scheduled in the response and monitors contention resolution as shown in part (a) of FIG. 2. If contention resolution is not successful after MSG3 (re)transmission(s), the WTRU goes back to MSG1 transmission.

The MSGA of the 2-step RA type includes a preamble on PRACH and a payload on Physical Uplink Shared Channel (PUSCH). After MSGA transmission, the WTRU monitors for a response from the network within a configured window. For CFRA, dedicated preamble and PUSCH resource are configured for MSGA transmission and, upon receiving the network response, the WTRU ends the random access procedure as shown in part (d) of FIG. 2. For CBRA, if contention resolution is successful upon receiving the network response, the WTRU ends the random access procedure as shown in part (b) of FIG. 2; while, if fallback indication is received in MSGB, the WTRU performs MSG3 transmission using the UL grant scheduled in the fallback indication and monitors contention resolution. If contention resolution is not successful after MSG3 (re)transmission(s), the WTRU goes back to MSGA transmission. If the random access procedure with 2-step RA type is not completed after a number of MSGA transmissions, the WTRU can be configured to switch to CBRA with 4-step RA type.

For random access in a cell configured with Supplementary Uplink (SUL), the network can explicitly signal which carrier to use (UL or SUL). Otherwise, the WTRU selects the SUL carrier if and only if the measured quality of the DL is lower than a broadcast threshold. The WTRU performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

When Carrier Aggregation (CA) is configured, random access procedure with 2-step RA type is only performed on PCell while contention resolution can be cross-scheduled by the PCell.

When CA is configured, for random access procedure with 4-step RA type, the first three steps of CBRA always occur on the PCell, while contention resolution (step 4) can be cross-scheduled by the PCell. The three steps of a CFRA started on the PCell remain on the PCell. CFRA on SCell can only be initiated by the gNB to establish timing advance for a secondary TAG: the procedure is initiated by the gNB with a Physical Downlink Control Channel (PDCCH) order (step 0) that is sent on a scheduling cell of an activated SCell of the secondary TAG, preamble transmission (step 1) takes place on the indicated SCell, and Random Access Response (step 2) takes place on PCell.

### 3 POSITIONING IN 3GPP RELEASE 17 (REL-17) AND BEYOND

3GPP Rel-17 and Rel-18 supports WTRU-based and LMF-based (i.e., WTRU-assisted) positioning for RAT-dependent and RAT-independent positioning procedures. The WTRU behavior and the procedures for supporting positioning during initial access in terrestrial networks (TN) or non-terrestrial networks (NTN) (including one or more steps in any given positioning procedures, not limited to reception of broadcast channels, configuration, transmission/reception of initial access messages, transmission/reception of positioning signals, measurements and reporting) that may be supported by WTRU with low latency, high reliability, high power savings and high accuracy are unknown. Additionally, using LTE Positioning Protocol (LPP) procedures for determining the WTRU positioning information during initial access are unknown.

In typical random-access procedures, including 4-step RA type or 2-step RA type, a sequence of steps is performed by the WTRU and base station involving transmitting and/or receiving initial access messages such as RACH preambles/sequences, random access responses, contention resolution messages, etc., in the process of authorizing the WTRU, (re)establishing connectivity, and ensuring security. Upon (re)establishing connectivity and transitioning to RRC CONNECTED state, the WTRU may subsequently transmit/receive control/data plane messages securely to/from the network. Such procedures also may be performed each time the WTRU intends to transmit data while in INACTIVE/IDLE state, when moving into the coverage area of a new cell/base station, or when initiating any positioning procedures.

In DL based positioning methods, the WTRU performs measurements of resources associated with DL-PRS and sends measurement reports to the LMF based on assistance data provided by the network. In UL-based positioning methods, the WTRU is configured with SRS for positioning (SRSp) resources via RRC signaling. The transmission of the SRSp by the WTRU is then received by different TRPs/gNBs in the network for performing positioning measurements and reporting the measurements to the LMF. The LMF determines the WTRU location based on the positioning measurements. Such positioning procedures may be supported by the WTRU, possibly only after the initial access procedure is successfully completed.

Having to successfully complete initial access procedure each time for sending any data or initiating any positioning procedure may result in unnecessary overhead, increased latency, and decreased power efficiency. Even in the case where it may be beneficial for the WTRU to send its location information (e.g., acquired via GNSS positioning) to the network for AMF selection and authorization before being granted access to network (e.g., for NTN), the WTRU may need to successfully complete initial access procedure to ensure that the location information may be sent securely.

In this regard, a key problem is how to support positioning before or during initial access such that location information of the WTRU may be conveyed to the network efficiently and securely.

### 4 POSITIONING DURING INITIAL ACCESS

### 4.1 Overview

The term “SRS for positioning” shall refer herein to an SRS signal/transmission used for positioning. Resources for SRS for positioning (SRSp) may be defined (e.g., signalled) by RRC. In Release 16, SRS resource set and SRS resource configured for positioning are specified. However, “SRS for positioning” or “SRSp” or “SRS” in this disclosure may include one or more of the following: SRS which is configured under SRS-PosResourceSet-r16 and SRS-PosResource-r16 in TS 38.331 (16.1.0); SRS which is configured under SRS-ResourceSet and SRS-Resource in TS 38.331 (16.1.0); SRS which is not configured under SRS-PosResourceSet-r16 and SRS-PosResource-r16 in TS 38.331 (16.1.0); SRS which is not configured under SRS-ResourceSet and SRS-Resource in TS 38.331 (16.1.0); SRS which is not associated with SRS-PosResourceSet-r16, SRS-PosResource-r16, SRS-ResourceSet or SRS-Resource in TS 38.331 (16.1.0); Uplink reference signal that is associated for positioning; Demodulation-Reference Signal (DM-RS) for uplink; and/or PTRS for uplink.

For brevity, SRS for positioning is denoted as “SRSp”. PRS and SRS as used in this disclosure are not limited to RS used for positioning. The methods described herein may be applied to or used with any DL or UL reference signals.

### Positioning Configuration

A positioning configuration may include a set of information related to positioning measurement and/or SRSp transmission. One or more of following information may be included in a positioning configuration: positioning method used (e.g., DL-TDOA, UL-TDOA, DL-AoD, UL-AoA, Multi-RTT); PRS configuration; SRSp configuration; uplink resource (e.g., PRACH, PUSCH, PUCCH) to report the positioning measurement; one or more threshold values to determine the positioning measurement quality; positioning mode of operation (e.g., starting positioning mode of operation).

PRS resource configuration may include at least one of the following: PRS resource ID; PRS sequence ID, or other IDs used to generate PRS sequence; PRS resource element offset; PRS resource slot offset; PRS symbol offset; PRS QCL information; PRS resource set ID; List of PRS resources in the resource set; Number of PRS symbols; Muting pattern for PRS, muting parameters such as repetition factor, muting options PRS resource power; Periodicity of PRS transmission; Spatial direction information of PRS transmission (e.g., beam information, angles of transmission); Spatial direction information of UL RS reception (e.g., beam ID used to receive UL RS, angle of arrival); Frequency layer ID; TRP ID; and/or PRS ID.

SRSp resources configuration may include at least one of the following: Resource ID; Comb offset values, cyclic shift values; Start position in the frequency domain; Number of SRSp symbols; Shift in the frequency domain for SRSp; Frequency hopping pattern; Type of SRSp, e.g., aperiodic, semi-persistent, or periodic; Sequence ID used to generate SRSp, or other IDs used to generate SRSp sequence; Spatial relation information, indicating which reference signal (e.g., DL RS, UL RS, Channel State Information Reference Signal (CSI-RS), SRS, DM-RS) or Synchronization Signal Block (SSB) (e.g., SSB ID, cell ID of the SSB) the SRSp is related to spatially; QCL information (e.g., a QCL relationship between SRSp and other reference signals or SSB), QCL type (e.g., QCL type A, QCL type B, QCL type D); Resource set ID; List of SRSp resources in the resource set; Transmission power related information; Pathloss reference information which may contain index for SSB, CSI-RS or PRS; Periodicity of SRSp transmission; Spatial direction information of SRSp transmission (e.g., beam information, angles of transmission); and/or Spatial direction information of DL RS reception (e.g., beam ID used to receive DL RS, angle of arrival).

As the part of the configuration, the WTRU may receive information related to the cell ID, global cell ID, or TRP ID which is associated with PRS. For example, the TRP that transmits PRS is identified by the TRP ID, which may belong to a cell identified by the cell ID. The WTRU may be configured with timing information such as System Frame Number (SFN) offset for PRS or SRSp transmission. The offset is introduced to prevent the WTRU from receiving overlapping PRS in the time domain.

The WTRU may obtain the parameters or configurations related to SRSp or SRS in RRC, a MAC-CE (Media Access Control-Control Element), DCI (Downlink Control Information) or in a LPP (LTE Positioning Protocol) message. Alternatively, the WTRU may obtain the parameters, configurations or thresholds (e.g., threshold for RSRP) related to SRSp or SRS in a broadcast message (e.g., System Information Block (SIB)) or in dedicated signaling for the WTRU from the network.

In this disclosure, SRS and SRSp may be used interchangeably.

In this disclosure, positioning-based initial access and initial access for positioning may be used interchangeably when referring to any sequence of transmissions and receptions or procedures or functionalities associated with performing positioning of a WTRU before and/or during initial access.

### 4.2 Methods for Supporting UL Positioning Based Initial Access

### Overview of UL-Positioning During Initial Access

In one family of embodiments, the location information of a WTRU may be determined before or during initial access using any of the UL-based positioning methods (e.g., UL-TDoA, UL-AoA). The location of the WTRU may be determined based on the signals transmitted by the WTRU and/or measurements made by network nodes/entities at one or more base stations, gNBs, TRPs, and/or Positioning Reference Units (PRUs). Since the location of the WTRU may be determined based on measurements made at the network, any security issues possibly due to potential exposure of the WTRU location to eavesdropping entities during initial access may be mitigated.

For transmitting UL signals for positioning (e.g., RACH preambles, SRSp), the WTRU may use resources and/or configurations that may be received from the network. In this case, for ensuring that the network may be able to perform measurements of UL signals during initial access and subsequently determine the location of WTRU, the WTRU may explicitly or implicitly initiate the measurements at TRPs by transmitting initial access messages, for example. The measurement reports containing the measurements made by the TRPs in the network may be forwarded to an anchor base station, BBU, or CU in RAN or to the AMF or LMF for determining the WTRU location.

The following is an overview of approaches for determining the WTRU location with UL-based positioning during initial access:
Transmission and/or measurement of RACH signals
   In an example, the WTRU may transmit RACH preambles which may be received and measured by one or more TRPs at the network. The measurements made on the RACH preambles by the TRPs may include RSRP, RSTD, AoA, AoD, degree of correlation with known preambles/sequences, etc.
   In another example, the WTRU may transmit RACH preambles at the RACH occasions dedicated for requesting msg2 which may contain positioning related configurations (e.g., SRSp configurations). The RACH occasions dedicated for positioning or requesting msg2 which may contain positioning related configuration may be broadcasted by the network (e.g., SIB) or the WTRU may receive the configurations while the WTRU was in RRC_CONNECTED and/or via RRC_Release message.
Transmission and/or measurement of SRSp/SRS
   For example, the WTRU may transmit SRS for positioning (SRSp) or SRS when transmitting one or more initial access messages (e.g., Msg 1, Msg 3, Msg A). The location of the WTRU may be determined at the network based on any of RSRP, RSTD, and AoA measurements made by one or more TRPs.
Transmission and/or measurement of initial access messages
   For example, the location of the WTRU may be determined based on measurements (e.g., RSRP, RSTD, AoA, AoD) made on one or more initial access messages transmitted by the WTRU. The initial access messages transmitted by the WTRU may include Msg 1, Msg 3, Msg 5, and Msg A, for example.

The “UL signals”, described herein, may include any of the following:
One or more RACH preambles, sequences, partitions and resources, which may be possibly transmitted by WTRU during any of the RACH occasions
One or more SRS or SRSp (SRS for positioning) transmissions which may be performed by WTRU using any of SRS/SRSp resources, resource sets, beams, frequency layers and configurations

For performing positioning during initial access, any of the indications, signaling (e.g., control and data), messages, and configurations (e.g., PRS/SRSp resources/configurations) may be transmitted and/or received by WTRU in a combination of one or more of the following:
Broadcast signaling:
   For example, the WTRU may access/acquire information for performing positioning during and/or after initial access (e.g., receive positioning assistance data, receive PRS/SRSp resources/configurations, receive parameters/threshold values associated with positioning) via any of SIB, positioning SIB (posSIB), and Synchronization Signal Block (SSB).
RRC signaling
   For example, the WTRU may transmit/receive any of the request messages, response messages, and configurations associated with positioning and/or initial access via RRC messages
LPP signaling
   For example, the WTRU may transmit/receive any LPP messages during initial access by using any of the identifiers associated with LPP (e.g., LPP session ID, LMF ID, WTRU ID)
MAC CE
   For example, the WTRU may transmit/receive any of the request messages, response messages, configurations, activation/deactivation indications associated with positioning and/or initial access in one or more MAC CEs. In UL, the MAC CEs, possibly carrying any of request or response messages, may be multiplexed in PUSCH when transmitting Msg 3 or Msg A, for example. Similarly, In DL, the MAC CEs may be multiplexed in the Physical Downlink Shared Channel (PDSCH) when receiving Msg 2, Msg 4 or Msg B, for example.
Initial access messages
   For example, Msg 1, Msg 2, Msg 3, Msg 4, Msg 5
   For example, Msg A, Msg B
L1 channels
   For example, PUCCH, PUSCH
   For example, PDCCH, PDSCH
      Wtru Receives Resources and/or Configurations for Performing UL Positioning During Initial Access

In an embodiment, the WTRU may access the resources and/or configurations associated with UL signals to enable determining the WTRU location during initial access. Any of the UL signals, described herein, may be transmitted by the WTRU in and/or together with one or more Msg 1/Msg 3/Msg 5 (in 4-step RA type) or Msg A (in 2-step RA type) during initial access. The resources and/or configurations used by the WTRU for UL positioning may include one or more of the following:
RACH
   For example, the WTRU may transmit UL signals using one or more RACH resources, which may include preambles, sequences, partitions, time, and/or frequency resources associated with RACH. The RACH resources may also include RACH occasions that the WTRU may use when transmitting RACH preambles, for example. The parameters associated with RACH resources may include the start/stop time, transmission duration, periodicity, Tx power, Tx spatial direction, etc. The RACH resources may be selected by the WTRU from a set that may be common to multiple WTRUs or dedicated to the WTRU, for example. The common or dedicated RACH resources may be accessed via broadcast channel/beams (e.g., SIB, posSIB, SSB), via initial access messages (e.g., in Msg 2 or Msg B) or (pre)configured in WTRU, for example.
   The RACH resources accessed by the WTRU may be used for general initial access, dedicated for positioning purposes, or dedicated for any other services/slices (e.g., URLLC service). For example, the WTRU may have access to two sets/partitions of one or more RACH resources, where a first set may be intended to be used for positioning purposes and a second set may be intended to be used for non-positioning purposes (e.g., initial access). The different resources or resource sets may be associated with IDs/indexes that may be received by WTRU via broadcast or dedicated signaling.
   In an example, the WTRU, which may have access to a set of one or more positioning RACH preambles, may select a RACH preamble randomly or based on a selection criterion. For example, the selection criterion may indicate selecting a positioning RACH preamble when the RSRP measured on an DL signal (e.g., SIB, DL PRS, DMRS, SSB, TRS, CSI-RS) associated with RACH is above/below a threshold value.
   In an example when the WTRU transmits UL signals using the selected positioning RACH resources, the WTRU may implicitly indicate to the network that it should perform measurements and determine the location of the WTRU. In this case, the one or more TRPs that may receive the RACH signals transmitted by WTRU, may perform blind detection during the time occasions that may be associated with non-positioning and/or positioning based initial access, for example. In another example, the WTRU may implicitly indicate to the network that it should perform measurements for positioning by transmitting one or more RACH preambles during the one or more RACH occasions that may be associated with and/or dedicated/reserved for positioning. Such information on the availability of dedicated occasions for sending any UL signals for positioning may be received by the WTRU via broadcast channels/beams (e.g., SIB, flag in SIB, SSB) or preconfigured in the WTRU, for example. In one example, the WTRU may use the RACH occasions dedicated for positioning to request the network to initiate the positioning procedure during the initial access. For example, after the WTRU sends one or more RACH preamble sequences or SRSs during the dedicated RACH occasions, the WTRU may assume and/or determine that msg2 (e.g., RAR) may contain assistance information for SRSp that the WTRU shall transmit in msg3.
   In another example, when the WTRU transmits UL signals using non-positioning RACH resources, the WTRU may transmit an additional indication/flag for requesting the network to determine the WTRU location, possibly along with the RACH signal. The indication/flag may be transmitted by the WTRU prior to or after transmitting the RACH signal (e.g., in one or more Msg 1/Msg A transmissions), for example. Alternatively, the indication may be transmitted upon encoding/scrambling of the RACH signal, for example.
   In another example, the WTRU may use one or more RACH occasions and/or RACH sequences, possibly dedicated for the WTRU and/or for UL positioning purposes, based on the configuration information on RACH occasions/sequences which may be received by the WTRU via SIB, received during CONNECTED state or when transitioning to INACTIVE/IDLE state (e.g., in RRC Release or RRC Reconfiguration messages). The WTRU may also receive validity conditions (e.g., validity area/cells, validity time duration) associated with the resources (e.g., RACH occasions/sequences) for indicating where and/or when the resources may be valid for usage. Such RACH occasions/sequences may be provided to the WTRU by the network with the intention to allow the WTRU to perform positioning when in IDLE/INACTIVE state and/or during initial access, for example. The network may be able to uniquely identify the WTRU and/or locate the WTRU based on the RACH occasions/sequences used by the WTRU during initial access, for example.
SRS/SRSp
   In an example, the WTRU may transmit UL signals during initial access using one or more SRS or SRSp resources. The parameters associated with SRS/SRSp resources may include the time/frequency resources, start/stop time, transmission duration, periodicity, Tx power, Tx spatial direction, etc.
   The WTRU may select the SRS/SRSp resources from one or more resource sets common to multiple WTRUs or dedicated to that particular WTRU, for example. The common or dedicated SRS/SRSp resources may be accessed by the WTRU via broadcast channels/beams (e.g., SIB, posSIB, SSB) or (pre)configured in the WTRU, for example. The different SRS/SRSp resources/resource sets and/or SRS/SRSp parameters may be associated with IDs/indexes.
   The SRSp resources/configurations that may be configured and/or used by the WTRU for performing UL positioning during initial access may include any of aperiodic, semi-persistent, and periodic SRSp. For example, (i) aperiodic SRSp may result in a single shot transmission of SRSp, (ii) semi-persistent SRSp may result in periodic SRSp transmission over a configured time duration, and (iii) periodic SRSp transmission may result in periodic SRSp transmission until an indication to terminate may be received by the WTRU. Such SRSp transmissions (e.g., aperiodic, semi-persistent, periodic) may be performed by the WTRU before/during/after transmitting Msg 1, Msg 3, Msg 5 or Msg A, for example. For the case of periodic SRSp transmission, the WTRU may initiate SRSp transmission after/during transmission of Msg 3 and/or terminate the transmission after receiving Msg 4, for example.
   In an example, the WTRU may transmit SRS/SRSp during time occasions that may be dedicated for positioning purposes. In this case, the time occasions may be configured to occur periodically with certain configured periodically during which the WTRU may transmit SRS/SRSp and/or the TRPs may perform measurements on the SRS/SRSp for determining the WTRU location, for example. The configuration information on such time occasions and/or periodicity for transmitting SRS/SRSp for positioning may be received by the WTRU via broadcast channels/beams or preconfigured in the WTRU, for example.
   In an example, the WTRU, which may have access to one or more SRS/SRSp resource sets/configurations, may select an SRS/SRSp resource set/configuration randomly or based on a selection criterion. For example, the selection criterion may indicate selecting an SRS/SRSp resource set/configuration when the RSRP measured on one or more DL signals (e.g., SIB, DL PRS, SSB, DMRS, CSI-RS, TRS) associated with the SRS/SRSp is above/below a threshold value.
   In an example, a WTRU may have access to a first SRSp resource set configured with low density resources and a second SRSp resource set configured with high density resources. In this case, the WTRU may select the second SRSp resource set when the RSRP measured on an associated DL signal is below a threshold such that the selected SRSp during transmission may result in improving the quality of measurements at network and accuracy when determining the WTRU location.

Any of the resources, resource sets, and/or configurations, as a whole or in part, associated with UL signals for positioning (e.g., RACH, SRS, SRSp) before or during initial access may be received by the WTRU in a combination of one or more of the following:
Broadcast channels
   For example, the WTRU may receive information on RACH resources/occasions (e.g., positioning and non-positioning), and/or SRS/SRSp resources/occasions from any of SIB, posSIB and SSBs. The resources, resource sets, and/or configurations for positioning that may be used by WTRU during initial access or after establishing connectivity with the network (e.g., in RRC CONNECTED state) may be indicated with IDs/index values.
   In an example, the WTRU may receive information on the occasions during which the WTRU may transmit one or more of the UL signals for positioning and/or which the network may expect to receive and perform measurements on the signals transmitted by WTRU for positioning.
   In an example, the WTRU may receive information (e.g., IDs) on the parameters associated with UL signals (e.g., RACH, SRS, SRSp), which may include the Tx power (range, max) to be applied, offset values with respect to reference frame, numerology, QCL/spatial relation, TRP/cell ID, beam IDs, spatial direction to apply, etc. Such parameters may be used by the WTRU during transmission of UL signals or for indicating to the network when requesting one or more parameters during initial access (e.g., in on-demand request sent in Msg 1, Msg 3, Msg A), for example.
Paging
   For example, when the WTRU may be transitioned into RRC IDLE/INACTIVE state, possibly after previous connection establishment and/or operation in RRC CONNECTED state, the WTRU may receive information on resources to use for UL signals in one or more paging messages. In this case, the paging message(s) received by the WTRU may include the WTRU ID (e.g., paging RNTI), resources/configurations, and/or IDs/indexes associated with the UL signals (e.g., RACH, SRS and/or SRSp), for example.
   In an example, the WTRU may receive the information on UL signals in conventional paging occasions or new paging occasions dedicated for positioning.
Pre-configured/pre-defined in the WTRU
   For example, the WTRU may use the resources for UL signals which may be preconfigured/predefined and stored in the WTRU. Such pre-configurations may be received by the WTRU in previous LPP sessions (e.g., LPP assistance data, request location information messages), previous SIB/posSIB reception, and/or previous RRC configurations, possibly received when operating in RRC CONNECTED state, for example.
   In another example, the preconfigured resources for UL signals may be received when transitioning to RRC INACTIVE/IDLE state, possibly in one or more RRC Release (e.g., with Suspend Config) or RRC Reconfiguration messages.
   In another example, when receiving the preconfigured resources for UL signals, the WTRU may also receive validity information/conditions/criteria associated with the preconfigured resources. Such validity conditions may include validity area (e.g., list of cells), validity time (e.g., timer duration, timer), and/or validity measurement thresholds (e.g., thresholds corresponding to RSRP measurements of DL signals associated with the UL signals), which may indicate the conditions expected to be met for deciding on whether the preconfigured resources for UL signals are valid for usage.
During transmissions/receptions of initial access messages
   For example, the WTRU may receive the resources for UL signals (e.g., RACH, SRS, and/or SRSp) in one or more of Msg 2 (e.g., random access response message), Msg 4 (e.g., in 4-step RA type), and/or Msg B (e.g., in 2-step RA type) receptions. The WTRU may receive the resources upon transmitting an explicit or implicit request for resources for UL positioning in Msg 1 or Msg A, for example.
   For example, the WTRU may transmit an explicit request for resources used in UL positioning when transmitting a normal RACH signal in Msg 1/Msg A along with a request indication/flag, and/or when transmitting a normal RACH signal encoded/scrambled with the request indication. The WTRU may transmit an implicit request for resources for UL signals when transmitting a new RACH preamble/partition which may be associated with the request indication, for example. In another example, the WTRU may transmit an implicit request for resources when transmitting a RACH preamble during a RACH occasion which may be associated with and/or dedicated/reserved for transmitting a request message to network and subsequent allocation of resources.

In an example, the WTRU may receive the resources for UL positioning in one or more search spaces associated with a BWP and/or in different BWPs. For example, the WTRU may be configured with an association or a mapping relation between the RACH signal used by the WTRU when sending Msg 1/Msg A and one or more search spaces to monitor for receiving) in Random Access Response (RAR) (Msg 2/Msg B) the resources or an activation/deactivation indication (e.g., ID/index for UL positioning. Such association or mapping relation may be received by the WTRU in broadcast channel (e.g., SIB), in RRC message (e.g., RRC Release or RRC Reconfiguration), or it may be preconfigured in the WTRU. In this case, when the RACH signal used by the WTRU contains an explicit/implicit indication for requesting the resources or to activate preconfigured resources, the WTRU may receive the resources or activation/deactivation indication of the resources based on monitoring in the one or more search spaces associated with the RACH signal used by the WTRU.

In an example, the WTRU may receive the resources and/or configurations for performing UL positioning with any of the UL signals (e.g., RACH, SRS, SRSp) during initial access in multiple segments/subsets from any of the approaches indicated above. For example, the WTRU may receive a first subset of the resources for UL signals in the broadcast channel (e.g., SIB, SSB) and a second subset of the resources in Msg 2/Msg B. The WTRU may combine the first and second subsets of resources when transmitting the UL signals for positioning in subsequent transmissions (e.g., in Msg 3 or Msg 5). In another example, the WTRU may receive the different subsets/partitions of resources in multiple Msg 2 or Msg B messages (e.g., multiple RAR messages), which may be multiplexed in the same PDSCH or received in different PDSCHs. For example, when receiving a first subset of resources in the first Msg 2/Msg B, possibly containing an indication/flag indicating transmission of further resource subsets, the WTRU may wait for a certain duration (e.g., upon starting a timer) for the reception of the resource subsets in second Msg 2/Msg B messages.

In another example, the WTRU may receive the one or more resources, resource sets, and/or configurations for UL positioning (e.g., with RACH, SRS, SRSp) via broadcast channel (e.g., SIB, posSIB, SSB) or preconfigured in the WTRU. The received resources, resource sets, and/or configurations may be associated with some IDs/indexes. The received resources and/or configuration may not be initially activated during reception from broadcast channel or during pre-configuration. Such resources/configurations may be activated upon triggering initial access. For example, after transmitting Msg 1/Msg A for triggering initial access, where the Msg 1/Msg A may possibly include an explicit or implicit request for triggering UL positioning, the WTRU may receive an indication from the base station in Msg 2/Msg 4/Msg B indicating the activation of one or more resources associated with UL signals. The activation indication may include the ID/index of the resources and/or configuration to apply when transmitting the UL signals, for example. The WTRU may transmit the UL signals using the activated resources/configuration for performing positioning of the WTRU, for example. For example, the WTRU may perform a first SRSp transmission in Msg 3, possibly using SRSp resources received and/or activated via Msg 2. The WTRU may perform a second SRSp transmission in Msg 5, using the same SRSp resources used during first SRSp transmission or using SRSp resources received and/or activated via Msg 4 (e.g., WTRU/NW may use 2-step approach to optimize the SRSp resources), for example.

In another example, the WTRU may identify the resources and/or configurations for UL positioning during initial access based on semi-static configuration between the resources and any of the following: service type (e.g., NTN, URLLC), cell type (e.g., NTN cell, TN cell), base station type (e.g., gNB, TRP, IAB node), and Public Land Mobile Network (PLMN) type (e.g., public network, private network). Such semi-static configuration may be received by the WTRU in the broadcast channel (SIB), in an RRC message, or it may be preconfigured in the WTRU. For example, when triggering positioning during initial access to an NTN cell, the WTRU may determine the resources for transmitting UL signals (e.g., RACH, SRSp, SRS) associated with NTN cell based on a semi-static configuration received in SIB indicating the mapping between the cell type and resources.

In another example, the WTRU may select SRSp configurations and/or determine parameters of SRSp based on a configured criterion associated with positioning. The parameters of SRSp may include the SRSp type (e.g., aperiodic, semi-persistent, periodic), Tx power, periodicity, time/frequency offsets, number of repetitions, density of resources, etc. For example, the WTRU may initially estimate the distance(s) between the WTRU and one or more TRPs based on RSRP and/or path loss measurements made on a DL RS (e.g., SSB) received from the TRPs. The WTRU may then select SRSp configurations and/or adjust one or more SRSp parameters such that measurements may be performed efficiently and reliably at the TRPs located at the estimated distances based on the SRSp transmitted by WTRU.

In another example, the WTRU may receive association between band/BWP/frequency layer and SRSp configurations (e.g., number of symbols/slots, periodicity). For example, the WTRU may receive the association between SRSp periodicity and BWP, associating 10 ms with BWP1 and 5 ms with BWP2. The WTRU may receive such association information in the broadcast channel. The WTRU may determine the SRSp configuration when the BWP ID is indicated by the network in subsequent messages, e.g., msg2 or msg4. Based on the association information between BWP and SRSp configuration and indicated BWP ID, the WTRU may determine SRSp configuration and apply the configuration when the WTRU transmits SRSp during the initial access procedure (e.g., msg1, msg3 or msg5).

### Wtru Transmits UL Signals Over Multiple Occasions or Repetitions for Positioning During Initial Access

In one embodiment, the WTRU may transmit any of the UL signals for positioning based on a set of one or more resources/preambles/sequences/partitions which may span over one or more repetitions and/or time/frequency occasions.

For example, a WTRU may be configured with one or more occasions for transmitting a combination of any of the UL signals (e.g., RACH, SRS, SRSp) for positioning. The occasions during which the WTRU may transmit the UL signals may be defined by any of the following parameters: one or more contiguous or non-contiguous time slots and/or symbols in time domain, one or more contiguous or non-contiguous subcarriers and/or PRBs in the frequency domain, start offset value with respect to a reference slot/frame/PRB, and periodicity value of the occasion (e.g., periodicity during which the occasion may repeat/recur). For example, the WTRU may transmit a RACH preamble (e.g., non-positioning or positioning) in a first occasion and SRSp in a second occasion, where the first and second occasions may be associated/dedicated for UL positioning. In another example, the WTRU may transmit repetitions of the same or different RACH preambles or SRSp in both the first and second occasions associated with UL positioning.

The WTRU may transmit the UL signals in multiple occasions in Msg 1/Msg A or in Msg 3/Msg 5, for example. In this case, the one or more TRPs in the network may expect to receive and perform positioning measurements on the UL signals transmitted by the WTRU during the configured occasions associated with UL positioning, for example. In an example, the network (e.g., gNB, TRPs) may perform blind detection for determining whether the WTRU transmits repetitions of RACH preambles or a mix of RACH preamble followed by SRSp during the first and second occasions. In another example, the WTRU may receive configuration information (e.g., via SIB, RRC messages, pre-configurations) on the repetitions and/or occasions to apply, including the number of repetitions allowed, periodicity of occasions, and the type of UL signals that the WTRU may transmit during the occasions (e.g., RACH preamble in first repetition occasion, SRSp in second repetition occasion and SRSp in third repetition occasion).

In an example, the number of repetitions or occasions to use when transmitting any of the UL signals may be semi-statically (pre)configured in the WTRU via broadcast channel, LPP, or RRC messages. In this case, the WTRU may transmit the UL signals for N number of repetitions or over N occasions during initial access based on the received (pre)configuration information, for example. In another example, the number of repetitions or occasions for transmitting UL signals may be increased or decreased based on certain events detected by the WTRU during initial access. For example, the WTRU may increase the repetitions for transmitting any of the UL signals from N to N+1 if it determines that the RSRP of a DL signal (e.g., SSB, CSI-RS) associated with the UL signal is below a threshold value. The WTRU may increase the number of repetitions or occasions when receiving an indication from the network (e.g., in Msg 2, Msg 4 or Msg B) that the previous UL transmissions were not decodable or successfully received/measured, for example.

In another example, the WTRU may determine the number of repetitions or occasions that may be used based on the number of RACH preambles or SRSp configurations available/accessible (e.g., via SIB, LPP, RRC). For example, when the number of RACH preambles and/or SRSp configurations available are less than a threshold value, the WTRU may use a low number of repetitions or occasions, possibly for mitigating the probability of collision/interference during transmission. In an example, when the number of RACH preambles and/or SRSp configurations available is less than or above a threshold value, the WTRU may use a hopping/skipping pattern when transmitting RACH preambles or SRSp over several repetitions or occasions. Such hopping/skipping pattern, possibly used for contention resolution and/or minimizing probability of collision/interference, may be received by the WTRU via SIB or pre-configured in the WTRU, for example.

In another example, the WTRU may receive configuration from the network for one or more RACH occasions used for RACH preamble repetitions (e.g., repeating transmission of preamble sequences at one or more occasions). The WTRU may receive such configuration in the broadcast channel (e.g., SIB). The WTRU may receive additional information from the network, possibly indicating that the WTRU may use a dedicated portion of the RACH occasions for transmission of the preamble for positioning. Alternatively, the WTRU may receive additional information from the network indicating that the WTRU may use a dedicated portion of the RACH occasions for transmission of SRS for positioning. Depending on WTRU capability, the WTRU may determine to use RACH occasions for the preamble repetitions for transmission of the preamble for positioning or SRSp.

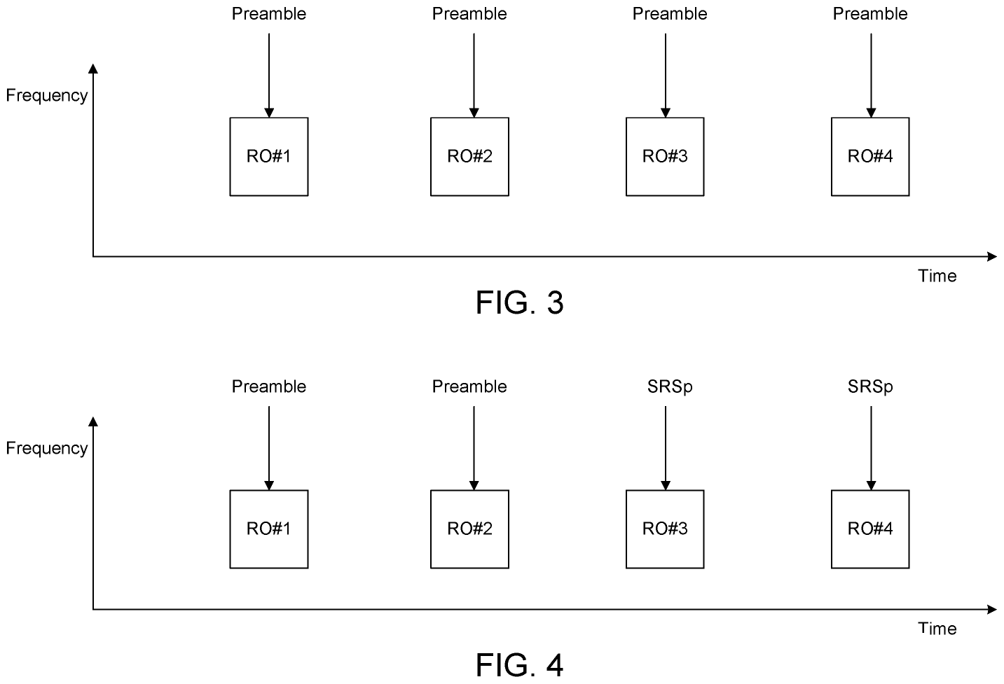

For example, as illustrated in FIG. 3, RACH occasions (RO) may be distributed in the time and/or frequency domains, occupying time and frequency resources. FIG. 3, for example, illustrates a set of ROs distributed in time where the ROs occupy the same frequency resources.

As illustrated in FIG. 3, the WTRU may determine to send preamble repetitions on ROs that are allocated for sending preamble repetitions.

A WTRU that requests positioning during initial access may determine to send SRSp in one or more RACH occasions used for preamble repetitions as illustrated in FIG. 4. The WTRU may determine to send SRSp in RACH occasions for preamble repetitions if the network broadcasts sub-partitions which may allow the WTRU to use one or more RACH occasions to send SRSp or preamble for positioning.

Wtru Assists Network in Performing Contention Resolution when Transmitting UL Signals During Initial Access

In one embodiment, the WTRU may assist the network in mitigating and/or resolving contention when supporting UL positioning during initial access based on the usage of explicit/implicit identifiers for uniquely identifying the WTRU. When performing positioning during initial access, contention/collision may occur in the following scenarios:
Inability to decode the UL signals transmitted by WTRUs
   For example, when multiple WTRUs transmit the same RACH preamble (positioning or non-positioning) and/or transmit SRSp using the same set of SRSp resources in the same occasion in a cell, the base station may detect a contention/collision event. Such contention/collision may result in the inability at the base station to identify the one or more WTRUs that may have transmitted the UL signals. Such contention may occur during the transmission of Msg 1/Msg A, for example. A similar contention/collision may occur when the WTRUs transmit SRS/SRSp with and/or after Msg 1/Msg 3/Msg A, for example.
Inability to decode scheduled UL messages (e.g., Msg 3) transmitted by WTRUs
   For example, when multiple WTRUs transmit data/control message (e.g., RRC setup request message in PUSCH) using the same UL resource grant received in the random-access response (RAR) message (e.g., in Msg 2), the base station may detect a contention/collision event. In this case, even when the WTRUs include a unique WTRU ID (e.g., NAS WTRU ID) in the transmission, the base station may not be able to unambiguously identify the WTRUs. A similar contention/collision may occur when multiple WTRUs transmit SRSp using SRSp resources indicated in the RAR message, for example.

The following describes the different actions that may be applied by a WTRU, individually or in combination of one or more actions, for assisting the network in mitigating and/or resolving such contention.

In an example, for mitigating contention when supporting positioning during initial access, the WTRU may select SRSp resources for transmitting SRSp based on their predefined/preconfigured association with the selected RACH preambles. For example, the WTRU may select and transmit one or more RACH preambles in Msg 1/Msg A. The selected RACH preamble(s) (e.g., positioning or non-positioning) may be associated with a set consisting of one or more SRSp resources/configurations. Such association information between the RACH preambles and SRSp resources may be received by the WTRU via SIB, received via RRC messages, or preconfigured in the WTRU. When the WTRU receives and/or successfully decodes a random-access response (RAR) message in Msg 2/Msg B, this may possibly imply that the base station may have successfully received the RACH preamble transmitted by the WTRU without contention. In this case, the WTRU may transmit SRSp, possibly with or after Msg 3, by using the SRSp resources associated with the transmitted RACH preamble, for example.

In another example, the WTRU may include any information on identifiers received in the RAR message (e.g., in Msg 2, Msg B), received in SIB, or received previously (e.g., when the WTRU is in CONNECTED state via RRC messages) when determining the SRSp resources and/or when transmitting SRSp using the determined/indicated resources. For example, the WTRU may include any of the identifiers, including the ID of RACH preamble (e.g., used in Msg 1/Msg A), ID of the WTRU (e.g., NAS WTRU ID, TMSI, C-RNTI, TC-RNTI), and ID of the SRSp/SRR configuration when transmitting SRSp. One or more of such IDs may be transmitted by the WTRU before/during/after transmitting SRSp in an occasion associated with the SRSp (e.g., an occasion occurring before/after SRSp transmission). Such IDs may be encoded on the messages transmitted before/during/after transmitting SRSp or encoded on the SRSp (e.g., scrambling the ID on SRSp resources) and transmitted along with the SRSp, for example. For example, the WTRU may transmit one or more of the IDs when transmitting an UL message in Msg 3/Msg A (e.g., RRC Setup request) in a first occasion. The WTRU may transmit SRSp using SRSp resources in a second occasion which may be associated with the first occasion and/or occurs within a configured time duration before/after the first occasion (e.g., after an offset time, after N occasions configured to occur periodically), for example. Such transmission by the WTRU over multiple occasions may enable the base station to associate the SRSp received in an occasion with the ID of the WTRU received in another associated occasion, for example.

An example of ID of the WTRU encoded on the SRSp may be at least one of the following:
A sequence of symbols used for SRSp generated based on the ID of the WTRU. For example, a random number is generated based on the seed which is derived based on the ID of the WTRU. Alternatively, the sequence is generated as a function of at least the ID of the WTRU.
Resources of the SRSp are determined by the WTRU ID. For example time and frequency location and amount of resources (e.g., resource elements, number of symbols) is determined based on the ID of the WTRU. The WTRU may determine the location of SRSp and amount of resources used for SRSp based on a look up table configured by the network

In another example, where the WTRU may have access to multiple SRSp configurations (e.g., via SIB), the WTRU may select an SRSp configuration for transmitting SRSp based on reception of one or more IDs (e.g., WTRU ID, C-RNTI, NAS ID) that may uniquely identify the WTRU and the association between the SRSp configuration and WTRU IDs. Such IDs may be received in different initial access messages, including one or more RAR messages (Msg 2/Msg B) or one or more Msg 4 after the WTRU transmits RACH preamble in Msg 1/Msg A or UL control/data message in Msg 3, for example. The association between the SRSp configuration and WTRU IDs (e.g., received in initial access messages) may be determined based on the occasion/time slot during which the WTRU IDs may be received by the WTRU. In this case, when the WTRU ID is received in a first occasion (e.g., in first RAR message) and the first occasion may be associated with a first SRSp configuration, the WTRU may select the first SRSp configuration for transmitting SRSp, for example. Such association between the SRSp configuration and reception of initial access messages may be received by the WTRU in SIB, received in RRC messages, or preconfigured in the WTRU, for example.

In another example, the WTRU may use the information on parameters received in the RAR message, SIB, or in previous pre-configurations when transmitting SRSp. For example, the WTRU may use the Timing Advance (TA) value/TA command received in RAR message (e.g., Msg 2/Msg B) for adjusting the SRSp resources with suitable timing/frequency offsets based on the TA value. The WTRU may transmit the SRSp using the SRSp resources adjusted based on the TA value, for example. Such adjustments to SRSp may enable the base station to mitigate contention between multiple WTRUs that may transmit SRSp using the same SRSp resources.

In another example, when a WTRU may have access to multiple SRSp resources/configurations (e.g., received via SIB, via RAR message or preconfigured in WTRU), the WTRU may select an SRSp based on measurements made on one or more DL signals/channels (e.g., SIB, DL PRS, DMRS, SSB, TRS, CSI-RS, PDCCH/PDSCH received in Msg 2, Msg 4, or Msg B), which may possibly be in spatial/QCL relation with the SRSp. The one or more SRSp configurations may comprise resources with different densities and/or repetitions (e.g., high and/or low density, high and/or low repetition periodicity). The association information between the SRSp configuration and the DL signals/channels and/or threshold values (e.g., RSRP) associated with the measurements may be received by WTRU in a combination of messages, including via SIB, RAR message, or RRC messages or may be preconfigured in the WTRU, for example. The WTRU may select an SRSp configuration when the RSRP or path loss measurements made on an associated DL signal is above/below a threshold, or when the distances estimated between the WTRU and TRPs are above/below a threshold, for example. For example, the WTRU may select an SRSp configuration with high density and/or transmit SRSp using the selected SRSp configuration when the measured RSRP of the associated DL signal (e.g., Msg 2) is below a threshold value. Such selection of SRSp configuration may enable the base station to resolve contention and/or perform measurements of SRSp with high accuracy, for example.

In another example, the WTRU may use a hopping/skipping pattern when transmitting the SRSp, possibly over multiple repetitions based on a hopping/skipping pattern that may uniquely identify the WTRU and/or may be received from network. Such hopping pattern may indicate which of the SRSp transmissions may be hopped/skipped over one or more occasions during which SRSp may be transmitted, for example. For example, the WTRU, which may be preconfigured or may have access to one or more hopping patterns via SIB, may receive in Msg 2/Msg 4/Msg B the ID of the hopping pattern to use when transmitting SRSp. The WTRU may use the indicated hopping pattern when transmitting SRSp, which may possibly allow the base station to perform measurements of SRSp with minimal or no contention/collision, for example.

### Wtru-Assisted Positioning During Initial Access for Non-Terrestrial Network (NTN)

In one embodiment, the WTRU may report information during initial access and/or RACH to assist network-based positioning, assist in verification of the WTRU location, or to improve positioning accuracy. This information may be used, for example, for proper AMF selection or Cell Global Identity (CGI) construction, or fulfillment of regulatory requirements such as lawful intercept or emergency services. Examples of such information (collectively referred to herein as “WTRU positioning assistance information”) may include one or more of: a WTRU estimate of WTRU-satellite distance, WTRU-satellite round trip time (RTT), WTRU-gNB distance, WTRU-gNB RTT, WTRU-reference point distance or serving cell, WTRU-reference point RTT of serving cell, WTRU-reference point distance of one or more neighboring cells, WTRU-reference point RTT of one or more neighboring cells, the current serving beam, a list of all detected beams, measurements of one or more detected beams (e.g., RSRP), the azimuth angle, expected time of arrival, RTT or RSTD expressed in terms of range of timing expressed in terms of seconds, symbols, slots or frames, for example. Angular information may be included in WTRU positioning assistance information, such as AoA of detected beams (e.g., from satellite, base station or TRP), AoD of SRSp, expected AoA or AoD of detected beams which may include uncertainty expressed in terms of range of values.

In one embodiment the WTRU may report one or more of the above data during the RACH procedure, for example, within MsgA/Msg3 and/or Msg5. The WTRU may include all requested/configured/triggered pieces of information within a single Transport Block (TB) or may include information in multiple messages. The information may be repeated over multiple messages or may alternatively have different pieces of information included in different messages. The WTRU may select which message to transmit the WTRU positioning assistance information in, for example, based on explicit indication (e.g., within SIB, RACH configuration, or RRC configuration), the grant size, whether the WTRU is provided with relevant information to perform the necessary calculation (e.g., the WTRU may choose not to include information regarding the WTRU-reference point distance/RTT if the reference point coordinates were not included in SI), whether the RACH was contention-based or contention free, and/or whether the RACH was 2-step or 4-step. In another embodiment, the WTRU may transmit one or more of the above data in the first UL grant received upon completion of the RACH procedure.

In one embodiment, the WTRU may include one or more pieces of WTRU assistance information for initial access positioning in a MAC CE (e.g., a Positioning assistance MAC CE). Transmission of the Positioning assistance MAC CE may be controlled by a reporting procedure (e.g., a Positioning Assistance Reporting (PAR) procedure). The PAR may be controlled by RRC configuration or System Information, and may include configurable Information Elements (IEs) that, for example, enable or disable the PAR procedure, describe triggering criteria (e.g., distance based thresholds, time-based thresholds), which WTRU positioning assistance information to include in the MAC CE, or which message to include the positioning assistance MAC CE. In another embodiment, such information may be transmitted via RRC signaling.

### WTRU Transmits UL Signals for Positioning Based on Detection of Triggering Events/Conditions

In one embodiment, a WTRU may initiate and/or transmit any of the UL signals (e.g., RACH, SRS, SRSp) or indications for positioning during initial access based on detection of one or more triggering events/conditions, described herein. The WTRU may receive information on the triggering events/conditions to monitor and/or detect for initiating UL positioning via broadcast channel (e.g., SIB, SSB), via dedicated RRC messages (e.g., RRC Release, RRC Reconfiguration) or by pre-configurations in WTRU, for example.

The triggering events/conditions monitored by a WTRU for transmitting UL signals for positioning during initial access may include a combination of one or more of the following:
Reception of Location Services (LCS)/LPP indication from higher layers/application
   For example, the WTRU may trigger positioning based initial access when receiving an LCS request (e.g., Mobile Originated Location Requests (MO-LR)) by selecting a positioning RACH preamble or transmitting a RACH preamble in a RACH occasion configured for positioning.
   In another example, the WTRU may send capability information, or request for assistance information (e.g., PRS/SRSp configurations) for initiating positioning when transmitting Msg 1, Msg 3 or Msg A.
Detection reference locations/times
   For example, the WTRU may trigger positioning based initial access when detecting one or more TRPs, base stations, or PRUs (e.g., via SIB, SSB) that may support positioning. In an example, a WTRU which may be operating in INACTIVE/IDLE state and/or which may be preconfigured with a validity area (e.g., list of cells), may initiate positioning based initial access when detecting a cell ID that matches at least one cell in the validity area.
Priority associated with positioning
   For example, the WTRU may trigger positioning based initial access when the priority value associated with positioning (e.g., preconfigured in the WTRU or received by the WTRU via SIB) may be higher than the priority associated with data communications.
Event triggered/periodic
   For example, a WTRU operating in INACTIVE/IDLE state may trigger positioning based initial access when detecting one or more configured events (e.g., location of WTRU may have changed by a certain distance threshold, RSRP measurements of DL signals/channels are above/below some threshold values). Similarly, when configured with periodic positioning, the WTRU may trigger positioning based initial access periodically based on the configured periodicity.
Detection of a cell that supports initial access for positioning
   For example, if the WTRU discovers more than one cell and at least one of them supports initial access for positioning, during which the WTRU may transmit preamble for positioning or SRSp, the WTRU may prioritize initiating initial access with the cell that supports the initial access for positioning.
Broadcast information containing positioning related information
   For example, the WTRU may determine to initiate initial access for positioning if the SIB contains positioning related information such as SRSp configurations.
      WTRU Fallback Actions when Detecting Failure/Inability Conditions During Positioning Based Initial Access

In one embodiment, a WTRU may fall back to performing one or more actions associated with positioning and/or initial access when detecting any of failure conditions and/or indications indicating inability to perform positioning during initial access. When performing positioning during initial access, the failure/inability conditions that may trigger fallback actions in a WTRU may include a combination of one or more of the following:
Inability to identify/select suitable resources for UL signals
   For example, the WTRU may not be able to identify/select suitable RACH preambles (e.g., associated with positioning) or SRSp/SRS resources, possibly due to absence of indication of such resources/configurations in the SIB, absence of pre-configurations in the WTRU, expiry of any validity conditions (e.g., area or time) associated with such resources, etc.
   For example, the WTRU may not receive sufficient resources in UL grants to enable it to transmit data, possibly associated with positioning, WTRU assistance information and WTRU IDs, in one or more TBs
Collision of UL signals transmitted by WTRU
   For example, the one or more RACH preambles (e.g., positioning or non-positioning) and/or SRSp transmissions transmitted by WTRU may result in collision when another WTRU located in the same cell transmits using the same resources (e.g., RACH preambles/occasions, SRSp resources) at the same time.
Inability for TRPs to perform measurements
   For example, due to presence of multipath, NLOS and/or interference the SRSp transmissions from WTRU may potentially result in unreliable and/or inaccurate measurements at TRPs

The WTRU may detect any of the failure/inability conditions when performing positioning based initial access based on one or more of the following:
Reception of an explicit or implicit indication (e.g., in Msg 2, Msg 4, or Msg B) indicating positioning and/or initial access failure
   For example, the WTRU may receive an explicit indication in Msg 4, possibly along with any of WTRU IDs (e.g., NAS ID, C-RNTI, TC-RNTI), indicating positioning failure associated with transmission of SRSp (e.g., in or after Msg 3). The explicit indication may also contain information on one or more failure causes (e.g., ID of a failure cause), including inability to identify the WTRU (e.g., WTRU ID is not detected/decoded), inability to decode SRSp, low accuracy associated with positioning, detection of collision or interference event and low RSRP, for example.
   For example, the WTRU may receive an implicit indication of failure when receiving an ID or indication to activate a new SRSp configuration, new SRSp resources, indication to retransmit SRSp or initial access messages, indication to start prohibit/backoff/reattempt timer for a certain duration, indication/ID of the duration of a prohibit/backoff/reattempt timer, etc.
   After transmitting any of the UL signals for positioning (e.g., SRSp), the WTRU may receive an explicit or implicit ACK/NACK indication, possibly along with a WTRU ID, for indicating the positioning status on whether positioning of the WTRU is successful (e.g., SRSp measurements at network are successful), for example.
Expiry of configured timer
   For example, the WTRU may detect a failure/inability condition when a timer that may be set/started and allowed to run over a configured time duration, expires before the reception of any indication from the network. In this case, the WTRU may start the timer possibly after the transmission of any of UL signals (e.g., RACH, SRSp, SRS) and/or initial access messages (e.g., Msg 1, Msg 3, Msg A), for example. When a response message (e.g., RAR) or an indication expected by WTRU (e.g., ACK/NACK, TA, WTRU ID, preamble ID, SRSp configuration ID, etc. in Msg 2, Msg 4, Msg B) is not received before the expiry of the timer, the WTRU may determine a failure may have occurred, for example.
Failure count
   For example, the WTRU may detect a failure/inability condition when N previous transmissions of any UL signals or N previous reception of any associated DL signals indicate failure, explicitly or implicitly. For example, the WTRU may detect a failure when the previous N attempts during which a RACH preamble and/or SRSp was transmitted resulted in a failure. N is an integer that may be preconfigured in the WTRU.
Detection of failure/inability condition on associated UL and/or DL signal/channel
   In an example, the WTRU may detect a potential failure condition on a second UL signal when a failure is detected on an associated first UL signal. For example, the WTRU may detect a potential failure on SRSp transmission (e.g., in Msg 3 or Msg 5) when a failure condition is detected (e.g., explicitly or implicitly) on a previous RACH transmission (e.g., in Msg 1) and/or a previous SRSp transmission (e.g., in Msg 1, Msg 3). Similar detection of failure may be made by the WTRU when performing a repetition of SRSp transmissions.
   For example, the WTRU may detect a potential failure/inability condition when performing measurements on any of the DL signals (e.g., SIB, DL PRS, DMRS, SSB, TRS, CSI-RS, PDCCH/PDSCH received in Msg 2, Msg 4, or Msg B) that may be associated with the UL signals (e.g., RACH, SRS, SRSp) transmitted or to be transmitted by the WTRU. In an example, the WTRU may detect a potential failure on an SRSp transmission (e.g., in Msg 3) when measurements made on a previously received Msg 2 or Msg B indicate a failure (e.g., RSRP of measurements on Msg 2/Msg B are below/above a threshold).

The following describe the different fallback actions that may be applied by a WTRU, individually or in combination of one or more actions, when receiving any indication or detection of any of the failure conditions.

In an example, when a WTRU detects ad/or receives one or more indications of unavailability or inability to perform positioning during initial access, the WTRU may be fallback to using a conventional (e.g., non-positioning) initial access. Such indications may be received by the WTRU explicitly or implicitly via broadcast channels (e.g., SIB, SSB), or in any of initial access messages (e.g., in Msg 2, Msg 4, Msg B), for example.

In another example, a WTRU may be fallback to using a 4-step positioning based initial access from 2-step positioning based initial access procedure when the RSRP measurements made on one or more associated DL signals (e.g., SSB, SIB, Msg 2, Msg B) are below/above one or more RSRP threshold values or within/outside of one or more RSRP threshold ranges. A 4-step positioning based initial access may involve performing positioning (e.g., via RACH and/or SRS/SRSp transmissions) during the transmission/reception of messages associated with 4-step RA (e.g., Msg 1, Msg 2, Msg 3, Msg 4), for example. Similarly, a 2-step positioning based initial access may involve performing positioning (e.g., via RACH and/or SRS/SRSp transmissions) during the transmission/reception of messages associated with 2-step RA (e.g., Msg A, Msg B), for example. For performing 2-step/4-step positioning based initial access, the WTRU may be configured with RSRP threshold values and/or configured to perform measurements on corresponding DL signals. When detecting a triggering event for performing positioning during access, the WTRU may perform 2-step positioning based initial access when the RSRP measurements are above a configured threshold and/or remain above the threshold for a certain configured time duration, for example. Otherwise, if the RSRP measurements are below the threshold, the WTRU may perform 4-step positioning based initial access. In another example, when the RSRP measurements performed on a DL signal are below/above an RSRP threshold configured for non-positioning initial access, the WTRU may perform conventional initial access. For example, a WTRU may be configured with first and a second RSRP threshold values (e.g., min/max values). The WTRU may perform any of the following procedures: (i) 4-step positioning based initial access if the RSRP measured on DL signals (e.g., SSB) is above the first RSRP threshold, (ii) 2-step positioning based initial access if the RSRP measured on DL signals (e.g., SSB) is below the first RSRP threshold and/or above the second RSRP threshold, and (iii) Initial access (non-positioning) if the RSRPs measured on DL signals (e.g., SSB) are below the second RSRP threshold.

In another example, the WTRU may reattempt positioning during initial access by retransmitting any of the UL signals (e.g., reattempt transmission of RACH preambles or SRSp) after detection of any of the failure/inability conditions. The WTRU may retransmit SRSp after the expiry of a prohibit/backoff/reattempt timer, which may be started when detecting a failure condition associated with SRSp transmission, for example. The WTRU may retransmit SRSp after performing certain changes/adjustments to SRSp based on one or more parameters (e.g., TA value, Tx power, time/frequency offset values) which may be received by the WTRU in response messages (e.g., Msg 2, Msg 4, Msg B) or preconfigured in the WTRU, for example.

In an example, the WTRU may start a first timer associated with positioning during initial access and/or or contention resolution, upon transmitting one or more UL signals (e.g., SRSp) for positioning. When a positioning status indication/flag (e.g., ACK/NACK), possibly indicating whether a previous transmission of UL signals is successful, is not received by the WTRU before the expiry of the first timer, the WTRU may stop the first timer and/or start a second timer (e.g., backoff/reattempt timer) and let the second timer run for a (pre)configured duration. After the expiry of the second timer, the WTRU may reattempt and/or retransmit the UL signals for positioning, for example. After starting the second timer, if the WTRU receives an indication to retransmit the UL signals, the WTRU may stop the second timer and transmit the UL signals, for example. Similarly, when the previous N attempts (e.g., N may be preconfigured in WTRU or received by WTRU in SIB or Msg 2, Msg 4, Msg B) during which the WTRU may have transmitted UP signals resulted in a failure condition (e.g., positioning status indication is not received or a NACK is received), the WTRU may start the backoff/reattempt timer. The WTRU may then retransmit the UL signals after the expiry of the timer, for example.

In another example, when detecting a failure condition (e.g., ACK/NACK is not received after N transmission of UL signals, NACK is received, or no explicit or implicit indication is received before expiry of a configured timer), the WTRU may transmit one or more request messages to the network to request new resources/configurations associated with UL signals (e.g., RACH preambles, SRSp resources) for positioning. Such request messages may be transmitted explicitly by the WTRU in Msg 1, Msg 3, Msg 5 or Msg A, for example. Alternatively, such request messages may be transmitted implicitly by transmitting a RACH preamble or SRS/SRSp using a set of resources/configurations that may be associated with a request for new resources for UL signals, for example. The WTRU may also implicitly transmit a request message by transmitting any of the UL signals during one or more configured occasions which may be associated with the request for new resources, for example. In another example, the WTRU may transmit a request message for a second SRSp configuration after detecting a failure condition during a first SRSp transmission using resources in a first SRSp configuration. For example, the WTRU may transmit a request for a new/second SRSp configuration comprising high resource density or high repetition periodicity when detecting a failure condition during an initial SRSp transmission using resources in an initial SRSp configuration comprising low resource density or low repetition periodicity. The association information between first and second SRSp resources and/or configurations and/or the criteria for the WTRU for selecting/indicating one of the second SRSp resources/configurations in the request message may be received by the WTRU in the broadcast channel (e.g., SIB, SSB), received via initial access messages, and/or preconfigured in the WTRU, for example. After sending a request message, possibly for new resources for UL signals, the WTRU may start a timer and wait for a response message from the network. If a response is not received before the expiry of the timer, the WTRU may retransmit the request message after expiry of the timer or return to restarting the initial access procedure (e.g., resend Msg 1/Msg A), possibly after transitioning to IDLE/INACTIVE state and reassessing the SIB, for example.

In another example, the WTRU may receive, from the network, an ID which corresponds to the ID the WTRU included in msg3 or in msg1. The WTRU may determine if the contention is resolved by comparing the ID received from the network and the ID the WTRU transmitted in msg3 or msg1. If the ID does not match, the WTRU may restart the initial access procedure for positioning or normal initial access procedure, based on the number of attempts the WTRU is allowed to make for initial access for positioning. If the number of attempts has exceeded the limit, the WTRU may determine to perform the normal initial access procedure.

If the WTRU cannot establish the initial access for positioning during the time that the WTRU transmits PRACH or SRSp for positioning purposes, the WTRU may determine to fall back to the normal initial access where the WTRU does not send PRACH or SRSp for positioning purposes. In another example, when the WTRU falls back to the normal procedure from the initial access for positioning, the WTRU may determine to use the dedicated RACH occasions during the normal initial access procedure. For example, when the WTRU transmitted SRSp or PRACH over the PRACH occasions during initial access for positioning and the WTRU falls back to the normal procedure, the WTRU may determine to use the RACH occasions for PRACH repetitions.

### WTRU Transmits SRSp Based on Reception of Initial Access Response Messages

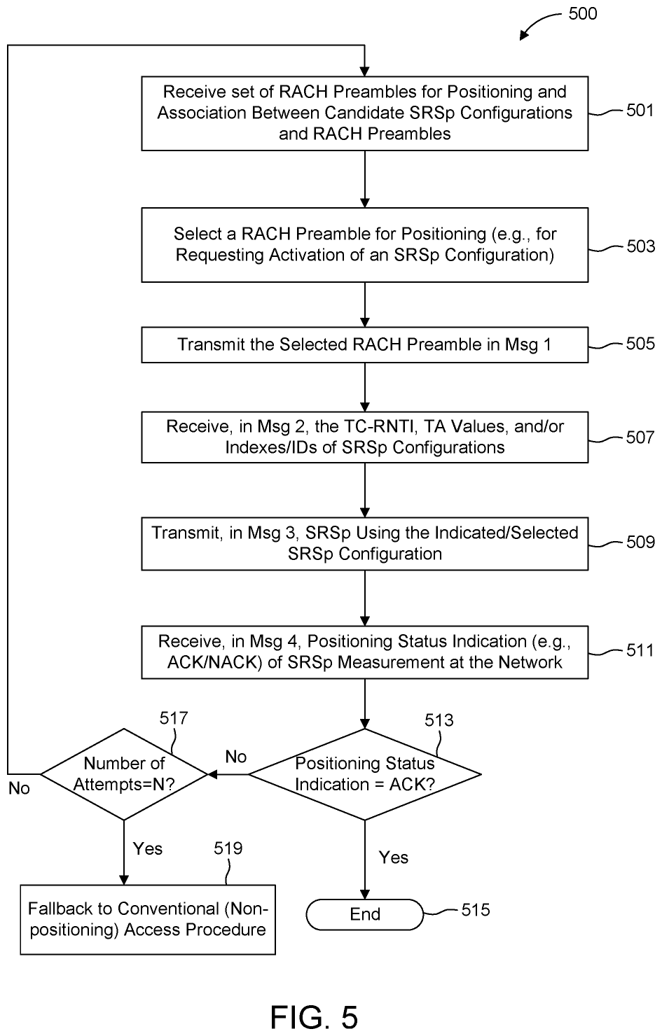

In one embodiment, a WTRU may transmit SRSp during initial access, in or after Msg3, based on SRSp resource configurations received in the SIB and an activation indication (e.g., SRSp configuration index/ID) received in Msg 2 or Mgs B. If the measurements of SRSp made by one or more TRPs at the network are not adequate (e.g., due to collision/inaccuracy), the WTRU may retransmit SRSp after a backoff timer period or after receiving an indication from network indicating failure to determine WTRU location, for example. An example procedure applied by the WTRU for transmitting SRSp based on reception of initial access messages is shown in the flowchart of FIG. 5 and described below.

At step 501, the WTRU may receive, e.g., in SIB, a set of RACH preambles for positioning and association information indicating the association between a set of candidate SRSp configurations and the RACH preambles. For example, such association may indicate the SRSp configurations that the WTRU may use for SRSp transmission based on the selection of a RACH preamble. Such association may also indicate the occasions during which the WTRU may transmit a RACH preamble such that it may result in implicitly indicating to the network a request for activating an associated SRSp configuration, for example. In an example, the SRSp configured may be configured with different parameters, such as SRSp configuration ID/index, resources density values (e.g., low, high), repetition periodicity, start offsets in time/frequency domain, duration of transmission (e.g., number of slots), number of beams, and spatial direction of beams.

At step 503, the WTRU may select a RACH preamble for positioning (e.g., for requesting activation of an SRSp configuration) and, in step 505, transmit the selected RACH preamble, e.g., in Msg 1. The WTRU may transmit the RACH preamble in an occasion dedicated for positioning, for example.

At step 507, the WTRU may receive, e.g., in Msg 2, the Temporary Cell Radio Network Temporary Identifier (TC-RNTI), one or more TA values (e.g., associated with positioning or non-positioning), and/or one or more indexes/IDs of SRSp configurations. For example, a reception of the index/ID of an SRSp configuration may indicate the activation of SRSp transmission using the indicated SRSp configuration. For example, when no indexes/IDs associated with an SRSp configuration are received or a reject indication is received, the WTRU may apply one or more fallback actions (e.g., restart initial access procedure be sending Msg 1). In the case when the WTRU may be configured to select an SRSp configuration or when receiving an indication/flag in msg 2 for selecting an SRSp configuration, the WTRU may select an SRSp configuration from a set of preconfigured candidate SRSp configurations based on a criterion. For example, the WTRU may select an SRSp configuration with low resource density/low number of repetitions when the RSRP measured on any of the DL signals (e.g., Msg 2, SSB) is above/below a threshold value. In another example, the WTRU may select SRSp configuration with low density/low number of repetitions as a default during the first SRSp transmission.

At step 509, the WTRU may transmit, e.g., in Msg 3, SRSp using the indicated/selected SRSp configuration. For example, when transmitting SRSp, the WTRU may perform adjustments to the SRSp configuration based on the TA value received in Msg 2. For example, the WTRU may transmit an ID of the WTRU (e.g., NAS WTRU ID, TMSI/IMSI) in Msg 3 (e.g., in PUSCH) before transmitting SRSp. In this case, the ID of the WTRU may be transmitted in a first occasion and the SRSp is transmitted in a second occasion associated with Msg 3. Alternatively, the WTRU may transmit the ID of WTRU along with SRSp, possibly by encoding SRSp with the ID (e.g., scrambling SRSp with the ID), for example. The WTRU may start a timer after transmitting Msg 3 (e.g., containing SRSp) and let the timer run for a configured timer duration. The time duration used for the timer may be associated with the duration of SRSp transmission, for example. The duration of the timer may be determined by the WTRU based on the association information received in the SIB or preconfigured in the WTRU, for example.

At step 511, the WTRU may receive, e.g., in Msg 4, the positioning status indication (e.g., ACK/NACK) of SRSp measurement at the network. The WTRU may also receive in Msg 4 an indication of the WTRU ID transmitted in previous Msg 3, for example. For example, if the WTRU receives an ACK status indication/flag, the WTRU may use the TC-RNTI as the C-RNTI when sending subsequent control/data messages (e.g., PUSCH in Msg 5). The ACK status indication/flag may be received explicitly along with the WTRU ID transmitted in Msg 3. Alternatively, the ACK status indication/flag may be received implicitly when the WTRU receives in Msg 4 the WTRU ID transmitted in Msg 3, for example. For example, if the WTRU receives a NACK status indication/flag, the WTRU may apply one or more fallback actions. The NACK status indication/flag may be received explicitly along with the WTRU ID transmitted in Msg 3. Alternatively, the NACK status indication/flag may be received implicitly when the WTRU does not receive in Msg 4 the WTRU ID transmitted in Msg 3 or when the WTRU does not receive any messages before the expiry of the timer started after transmitting Msg 3.

As shown at step 513, the WTRU may repeat the above procedure until an ACK status indication/flag is received from the network. In an embodiment, if an ACK status indication is not received after N attempts of retransmitting SRSp, the WTRU may fallback to initiating the conventional (non-positioning) initial access procedure, for example (steps 517 and 519). In an example, when an ACK indication is not received, or a NACK indication/flag is received, the WTRU may start a backoff timer and retransmit SRSp in Msg 5 after timer expiry. The WTRU may use the same SRSp configuration sent previously in Msg 3 or select a new SRSp configuration (e.g., with high resource density/high number of repetitions) when transmitting SRSp (e.g., in Msg 5), for example. Alternatively, when a failure cause (e.g., ID indicating the failure cause) is received in Msg 4, the WTRU may select a new SRS configuration for retransmitting SRSp based on an association information between the failure cause and SRSp configuration (e.g., received in SIB or preconfigured in WTRU), for example.

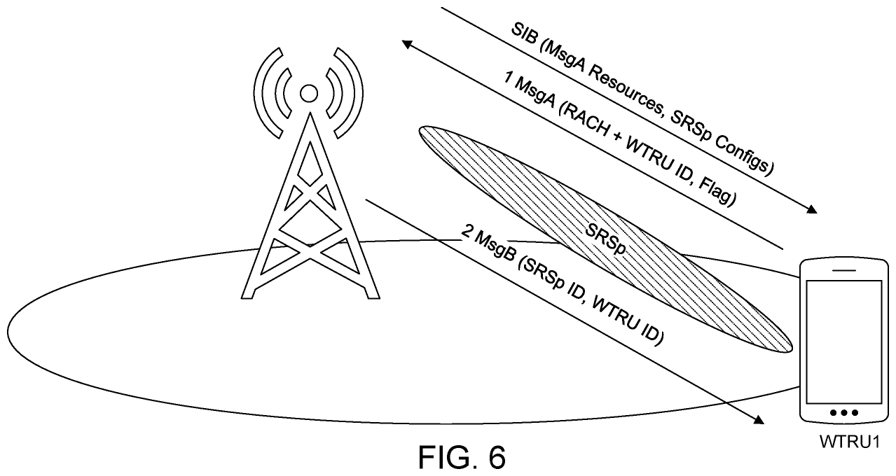

In one embodiment, referring to FIG. 6, a collision-free occasion with random access and positioning transmissions between a WTRU and network is provided. In this example, the WTRU receives broadcast transmissions (e.g., a SIB message indicating MsgA resources, and/or configuration information for SRSp transmissions). One or more broadcast transmissions the WTRU received may include configuration information that indicates resources for MsgA transmission (e.g., MsgA-PRACH, MsgA-PUSCH). The received configuration information (via broadcast transmissions) may include a set of SRSp resources (e.g., time-frequency and associated SRSp IDs). The WTRU transmits MsgA including, for example, a preamble, a WTRU ID, and/or an indication to transmit SRSp (e.g., an SRSp ID/flag in PUSCH). The WTRU may transmit a SRSp transmission using an SRSp resource selected from the set of SRSp resources. The WTRU may receive an acknowledgement (ACK) in MsgB from the network, which may include the WTRU ID and/or the SRSp ID (or an indication of the SRSp ID) associated with the transmitted SRSp resource. The SRSp ID in the MsgB is associated with the SRSp transmission and indicates the SRSp transmission was successfully received by the network (e.g., an ACK). The WTRU ID included in the MsgB indicates an ACK for a previous MsgA transmission.

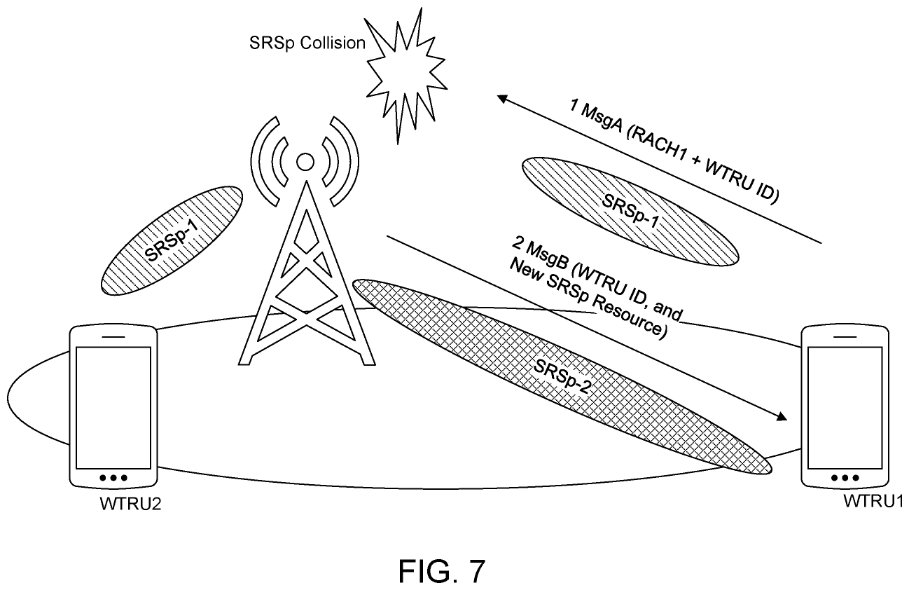

In one embodiment, referring to FIG. 7, SRSp transmissions collision happens. In this example, two devices, a first WTRU (WTRU1) and a second WTRU (WTRU2) transmit using same SRSp resource (SRSp-1), causing SRSp collision. The WTRU1 retransmits SRSp using a new SRSp resource received in MsgB. In this example, the received MsgB indicates an ACK for the transmitted MsgA (e.g., WTRU ID) and a NACK for the SRSp transmission (e.g., a new SRSp resource), and the WTRU transmits the SRSp using the new SRSp resource indicated in the MsgB.

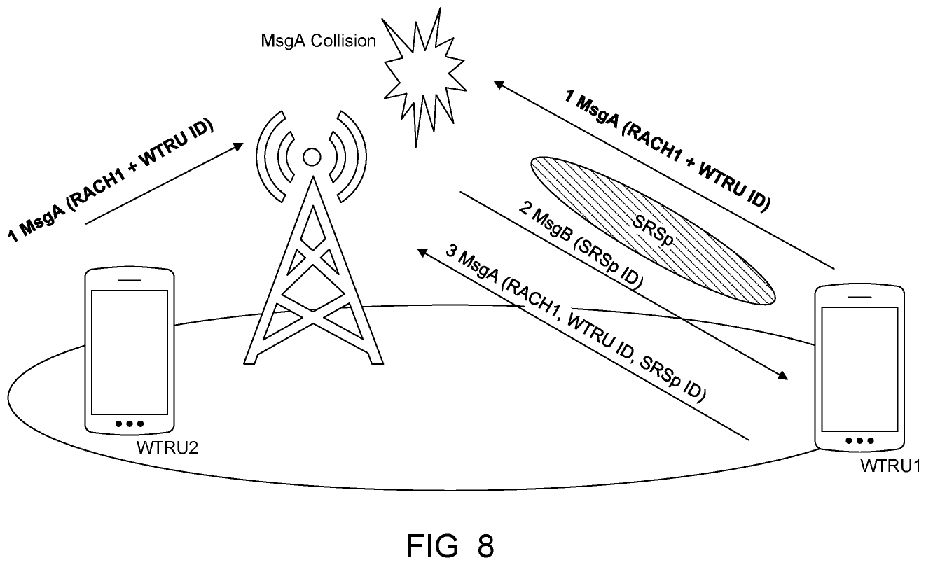

In another embodiment, referring to FIG. 8, MsgA collision happens. In this example, two devices, a first WTRU (WTRU1) and a second WTRU (WTRU2) transmit same PRACH preamble (RACH1), causing MsgA collision. SRSp transmitted by WTRU1 is successfully received by the network. WTRU1 retransmits and indicates previously transmitted SRSp ID. In this example, the received MSgB indicates an ACK for SRSp transmission (e.g., ID of previously transmitted SRSp) and a NACK for the transmitted MsgA, and the WTRU would transmit another MsgA and indicate the ID of previously transmitted SRSp.

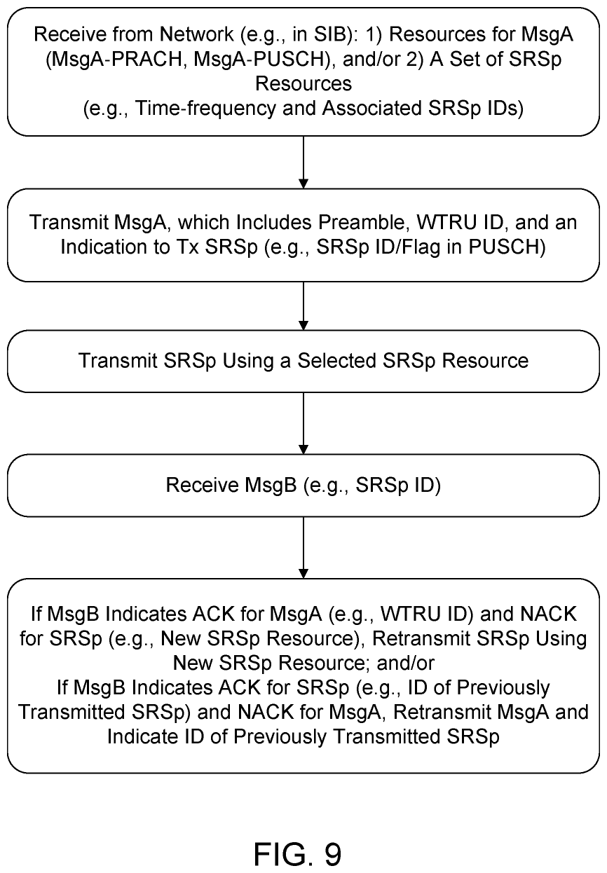

In one embodiment, referring to FIG. 9, a WTRU receives from network (e.g., in SIB) resources for MsgA (e.g., MsgA-PRACH, MsgA-PUSCH) and a set of SRSp resources (e.g., time-frequency and associated SRSp IDs). The WTRU transmits a MsgA, which includes one or more of: preamble, WTRU ID, and/or an indication to transmit SRSp (e.g., SRSp ID/flag in PUSCH). The WTRU transmits SRSp using a selected SRSp resource, and then the WTRU may receive a MsgB (e.g., SRSp ID) from the network. If the MsgB indicates an ACK for MsgA (e.g. UE ID) and a NACK for SRSp (e.g., new SRSp resource), the WTRU transmits SRSp using the new SRSp resource. If the MSgB indicates an ACK for SRSp (e.g., ID of previously transmitted SRSp) and a NACK for MsgA, the WTRU transmits a MsgA and indicates ID of previously transmitted SRSp.

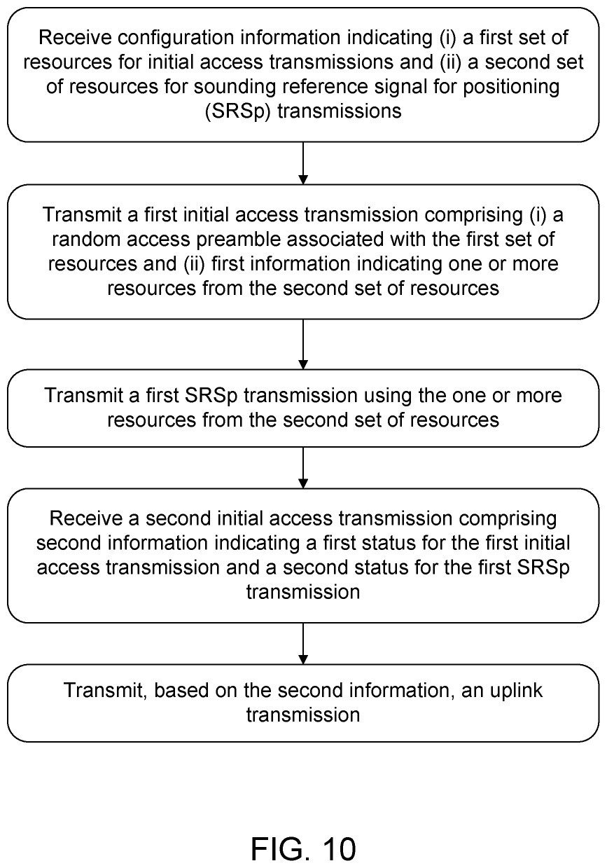

FIG. 10 is a flowchart illustrating an example operation of performing random access and positioning transmissions by a WTRU. In this example, a WTRU is configured to receive configuration information indicating (i) a first set of resources for initial access transmissions and (ii) a second set of resources for sounding reference signal for positioning (SRSp) transmissions; transmit a first initial access transmission comprising (i) a random access preamble associated with the first set of resources and (ii) first information indicating one or more resources from the second set of resources; transmit a first SRSp transmission using the one or more resources from the second set of resources; receive a second initial access transmission comprising second information indicating a first status for the first initial access transmission and a second status for the first SRSp transmission; and transmit, based on the second information, an uplink transmission.

In on example, the first status is an acknowledgement (ACK) indication for the first initial access transmission and the second status is a negative ACK (NACK) indication for the first SRSp transmission, and wherein the uplink transmission comprises a second SRSp transmission using one or more resources indicated in the second information.

In another example, the first status is a negative acknowledgement (NACK) indication for the first initial access transmission and the second status is an acknowledgement (ACK) indication for the first SRSp transmission, and wherein the uplink transmission comprises a third initial access transmission. In some cases, the ACK indication for the first SRSp transmission comprises an indication indicating the one or more resources from the second set of resources.

In an example, the third initial access transmission comprises the random access preamble or a different random access preamble associated with the first set of resources.

In an example, the configuration information is received on broadcast communications.

In an example, the configuration information is received on a system information block (SIB) message.

In an example, the first information comprises an identification of the one or more resources from the second set of resources for SRSp transmissions.

In an example, the second initial access transmission comprising second information indicating an identification of the one or more resources associated with the first SRSp transmission.

Evolution of the Content of msg3 and msg5

In another example, the WTRU may be preconfigured with more than one SRSp configuration. The WTRU may be configured with more than one SRSp configurations via broadcast (e.g., SIB). After the WTRU sends PRACH to the network, the WTRU may receive msg2 (e.g., RAR) from the network. The msg2 may contain an indication which SRSp configuration the WTRU shall use for msg3 (hereinafter termed the first SRSp configuration in this discussion).

After the WTRU transmits msg3 (e.g., SRSp with the indicated configuration), the WTRU may receive msg4 from the network which may contain an indication which SRSP configuration the WTRU shall use for msg5 (hereinafter termed the second SRSp configuration in this discussion). Subsequently, the WTRU may determine to transmit SRSp with the indicated SRSp configuration from the network.

The aforementioned first and second SRSp configurations may come from different sets of SRSp configurations. The first SRSp configuration may be based on sparse density of SRSp in both time and frequency domain (e.g., large comb values, small number of slots or symbols for SRSp). The second SRSp configuration may be based on dense density of SRSp in both time and frequency domain (e.g., small comb values, large number of slots or symbols for SRSp).

The indication for the first and second SRSp configurations may be an index for the configuration. For example, the WTRU may receive a look up table associating indices with SRSp configurations. The WTRU may determine the first and second SRSp configuration based on the look up table.

Alternatively, the WTRU may determine the first and second SRSp configurations based on implicit indication from the network. For example, the WTRU may receive a resource ID for CSI-RS or SSB in msg2 or msg4. The WTRU may determine to use the SRSp, in msg3 or msg5, that is spatially aligned with the indicated CSI-RS or SSB resource ID. For example, the WTRU may use the SRSp configuration that has the resource ID of CSI-RS or SSB as a reference RS in spatial information or QCL-D relationship. For example, if SSB #1 is indicated as the reference RS in spatial information of SRSp #2, it means that SSB #1 and SRSp #2 are spatially aligned.

In another example, the WTRU may receive a configuration of TRPs in msg2 or msg4. Based on the configuration, the WTRU may determine to transmit SRSp to more than one TRP. Alternatively, the WTRU may receive SRSp resource IDs, which may be implicitly or explicitly associated with TRPs, in msg2 or msg4. One example of association is spatial relationship. The association between SRSp and TRP may mean that SRSp is spatially aimed at TRP.

The WTRU may determine to transmit the configured SRSp to TRPs if time synchronization is established with the TRPs. For example, the WTRU may attempt to establish initial access with more than one TRP. The WTRU may receive RARs from more than one TRP. Based on the reception of RAR and indication from the network to transmit SRSp(s) to more than one TRP, the WTRU may determine to transmit the configured SRSp to the TRPs.

In another example, the WTRU may indicate which SRSp configuration (e.g., SRSp resource ID, SRSp resource set ID) it will use for msg3 or msg5 in msg1 or msg3, respectively. The indication may be based on preconfigured SRSp configurations. For example, the WTRU may include an ID corresponding to one of the preconfigured SRSp configurations in msg1 or msg3. Alternatively, to indicate on which SRSp configuration it will use in the subsequent PUSCH transmission, the WTRU may include the indication of an SRSp configuration in msg5.

### Srsp Density Ramping

In another example, if the WTRU is initiating initial access for positioning after one or more failed attempts, the WTRU may determine to change the parameters of the SRSp based on a pre-configuration. For example, the WTRU may determine to use higher density SRSp (e.g., higher density of SRSp in time or frequency) in msg3 during the second attempt to establish initial access. Alternatively, the WTRU may determine to increase the number of repetitions for SRSp in msg3 during the second attempt. As the number of attempts increases, the WTRU may increase density of SRSp or number of repetitions. The WTRU may be preconfigured with a look up table, associating the number of attempts and SRSp configurations (e.g., number of repetitions, comb values, number of symbols, frequency density). The WTRU may determine to use the SRSp configuration which is associated with the number of attempts made to complete the initial access for positioning. In the examples described herein, SRSp, SRS, and preambles may be used interchangeably.

### Completion of Initial Access for Positioning

Once the initial access for positioning is successful (e.g., the WTRU received an ACK message in msg 4 or was able to match an ID in msg4 with the ID sent in msg3), the WTRU may determine to enter IDLE mode. For example, the WTRU may transmit the configured SRSp in msg3 and once msg4 containing ACK is received by the WTRU, the WTRU may enter IDLE or INACTIVE mode. The WTRU may determine whether the WTRU enters IDLE, INACTIVE or RRC_CONNECTED after successful completion of initial access for positioning, based on WTRU capability or a broadcast message (e.g., SIB). The WTRU may send a request to the network to initiate initial access for positioning without entering RRC_CONNECTED mode. The WTRU may send the preamble in the RACH occasion that is dedicated for indicating whether the WTRU enters RRC_CONNECTED or RRC_IDLE after successfully completing the initial access procedure for positioning.

WTRU Selects Between 2-Step or 4-Step Positioning Based Initial Access Based on RSRP Measurements of DL RS Associated with UL-Positioning

In one embodiment, a WTRU may select and/or perform 2-step positioning-based initial access procedure when certain configured conditions are met (e.g., RSRP measurements of associated DL RS are above a threshold). Otherwise, the WTRU may perform 4-step positioning based initial access procedure or conventional initial access, for example. An example procedure applied by the WTRU for transmitting SRSp based on reception of initial access messages is as follows.

The WTRU may receive in the SIB a set of positioning RACH resources, a set of SRSp configurations, and one or more RSRP threshold values associated with DL RS (e.g., SSB) for selecting 2-step/4-step positioning-based initial access. The WTRU may also receive association information between one or more SRSp configurations and different DL RS. The WTRU may perform RSRP measurements on DL RS associated with one or more SRSp configurations. If the RSRP is greater than a first RSRP threshold value, the WTRU may perform 2-step positioning-based initial access procedure.

For example, when performing 2-step positioning based initial access procedure, the WTRU may transmit in MsgA, a RACH preamble and SRSp. The WTRU may transmit the RACH preamble in a first occasion associated with positioning and/or may transmit SRSp in a second occasion associated with positioning, for example.

The WTRU may receive in Msg B, an explicit or implicit indication/flag indicating the positioning status (e.g., ACK/NACK) on whether the measurements of SRSp at the network are successful, for example. The WTRU may also receive the TC-RNTI, C-RNTI, and TA value/command in Msg B, for example.

In the case when an ACK status indication is received, the WTRU may use the C-RNTI and TA value when transmitting subsequent control/data messages (e.g., in PUSCH). In the case when a NACK status indication is received, the WTRU may start a backoff timer and/or may retransmit the SRSp using the same or different SRSp configuration (e.g., selected by WTRU or received in Msg B) after the expiry of the backoff timer. The WTRU may retransmit the SRSp after performing certain adjustments to the SRSp configuration based on the received TA value, for example. If the RSRP is less than the first RSRP threshold value and/or greater than a second RSRP threshold value, the WTRU may perform the 4-step positioning based initial access procedure.

### 4.3 Methods for Transmitting Location Information During Initial Access

### Transmitting WTRU Location Information

In one family of embodiments, the WTRU may send the location information explicitly or implicitly to the network during initial access, based on the usage of one or more security approaches. Such security approaches may be applied to ensure that any external entities (e.g., eavesdropping entities) may not be able to decode the location information of WTRU from the initial access messages, which are typically transmitted/received prior to security activation in the WTRU (e.g., security activation at NAS layer and/or AS layer, such as PDCP layer encryption/ciphering) and/or configuration of radio bearers.

The location information of the WTRU may be determined before and/or during initial access, based on one or more of the following approaches:
GNSS based positioning:
   For example, the WTRU may determine its location information based on measurements made on GNSS signals.
RAT-dependent positioning:
   In an example, the WTRU may determine its location information (e.g., using WTRU-based positioning) using any DL-based positioning approaches (e.g., DL-TDoA, DL-AoD). The WTRU may perform measurements of PRS received from one or more TRPs for determining the WTRU location.
   In another example, the WTRU may determine its location information based on measurements made on the SSB/SS received from one or more TRPs and/or assistance data for performing Radio Resource Management/Enhanced Cell ID (RRMIE-CID) based positioning. Such measurements may be used for determining an initial WTRU location or first fix location with relatively low accuracy, for example.
   The assistance data, containing information on the PRS/RRM configurations to use for PRS/RRM measurements and/or for determining WTRU location, may be received by the WTRU via a broadcast channel (e.g., SIB, posSIB), received via paging messages (e.g., in a conventional paging occasion or new paging occasion associated with positioning), or pre-configured and/or stored in the WTRU (e.g., from a previous LPP session).
Initial access-based positioning
   For example, the WTRU may determine its location information based on indications associated with a TA value received in a RAR message (e.g., in Msg 2, Msg B) from one or more TRPs, possibly at different time instances. The TA values may be used for deriving the time difference information between transmission and reception of data, based on which the distance between the WTRU and TRPs may be estimated. Such time difference estimations may be used for estimating the WTRU location, for example.
   In another example, the WTRU may receive PRS in msg2 or msg4 and transmit SRSp in msg3 or msg5. The WTRU may also send a time difference between reception time of PRS and transmission time of SRSp. The time difference may be expressed in terms of absolute time in seconds, number of symbols, slots or frames, for example. The time difference may be used by the network to determine a round trip time between the network and WTRU.

Upon determining the location information, whether the WTRU may send the location information during initial access may depend on the WTRU capability. In this case, WTRU may transmit to the network an indication associated with WTRU capability for sending location information during initial access. Such WTRU capability information may be sent explicitly or implicitly when transmitting one or more RACH preambles in Msg 1/Msg A. For example, the WTRU may transmit a RACH preamble that may be associated with the indication of WTRU capability for transmitting the location information. Alternatively, the WTRU may send a RACH preamble in a RACH occasion that may be dedicated for indicating the WTRU capability information. In another example, the WTRU may include an indication/flag when transmitting a RACH preamble (in Msg 1/Msg A) or Msg 3 for indicating WTRU capability and/or for differentiating between other WTRUs (e.g., from legacy releases) that may not support such capability for indication location information. The information on such RACH preambles/occasions and/or indications/flags for indicating the WTRU capability information may be received by the WTRU via SIB or initial access messages (e.g., Msg 2, Msg B) or may be preconfigured in the WTRU, for example.

Upon determining the location information using one or more of the approaches described above, the WTRU may send the following in the initial access messages:
GNSS information
   For example, the WTRU may send the location information using absolute values (e.g., normal coordinates) or truncated values (e.g., abbreviated coordinates)
Area/zone information
   For example, the WTRU may send the ID/indexes of one or more areas/zones/sectors where the WTRU may be located. Such areas/zones may be predefined by the network to comprise a number of circular or rectangular grid points, where the grid points may be defined with a set of parameters (e.g., radius, length, width, area size). The information on such area/zone may be received by the WTRU via broadcast channel (e.g., SIB), via initial access messages (e.g., Msg 2, Msg B), or may be preconfigured in WTRU, for example.
   In an example, the WTRU may be configured to access one or more RACH preambles/resources based on the area where the WTRU may be located. Such RACH resources may be used by the WTRU for indicating to the network the location information of the WTRU based on the association between the area-based RACH preambles and the area where the WTRU may be located. For accessing the area-based RACH preambles, the WTRU may initially transmit a RACH preamble in Msg 1/Msg A, which may contain an explicit or implicit request for area-based RACH preambles. The WTRU may receive a response message (e.g., in Msg 2, or Msg B) containing information on the area-based RACH resources to use so that the location information may be transmitted by the WTRU. The response message may contain indications to one or more area-based RACH resources that may be dynamically updated by the network based on the initial RACH preamble transmitted by the WTRU, such that the WTRU may indicate its location information at different granularities/accuracies when transmitting the subsequent initial access messages (e.g., in Msg 3, Msg 5), for example.
Relative location information
   For example, the WTRU may send its relative location information with respect to one or more known reference points, such as TRPs, PRUs, broadcast reference points, and landmarks which may be in proximity to the WTRU. When detecting one or more cells/TRPs (e.g., via SIB), the WTRU may send its course/truncated location information by transmitting the cell/TRP IDs in the initial access messages, for example.
Location information obtained from RAT-dependent positioning methods
   For example, the WTRU may send the network location information the WTRU obtained while the WTRU was in RRC_CONNECTED or INACTIVE mode. The WTRU may have obtained the location information using at least one of the RAT dependent positioning methods (e.g., DL-TDOA, DL-AoD, UL-TDOA, UL-AoA, DL & UL positioning method). The WTRU may include a timestamp to indicate when the positioning information was obtained. Alternatively, the WTRU may include a timestamp to indicate when the WTRU reported the location information.

### WTRU Sends Location Information to Network Upon Using a Security Approach During Initial Access

The following describe the different approaches that may be applied by the WTRU, individually or in combination of one or more approaches, for transmitting the WTRU location information securely to the network.

In an example, the WTRU may access and/or transmit one or more RACH resources (e.g., RACH preambles, sequences, partitions or occasions) that may be associated with the location information of the WTRU. Such RACH resources/partitions may be configured at different granularities, for example, on a per area/zone basis, per-PLMN/AMF basis, per cell/TRP basis, per time window basis, per-WTRU basis (e.g., a PRU WTRU with known location may have access to one or more dedicated RACH resources), per-service basis, etc. The WTRU may use a combination of one or more RACH resources/partitions for indicating the WTRU capability, location information, and/or other information to the network.

In an example, a WTRU may determine its location information with a granularity level of a predefined area/zone where the WTRU may be located. The WTRU may select and/or transmit a RACH preamble that may be associated with the area/zone where the WTRU may be located, for example. In another example, the WTRU may indicate its consent/capability for disclosing its location information to the network by selecting one or more RACH preambles that may be dedicated to the WTRU and/or correspond to the area/zone where the WTRU may be located. In this case, the WTRU may send in one or more Msg 1/Msg A, a first RACH preamble in a first RACH occasion for indicating the WTRU consent/capability and a second RACH preamble in a second RACH occasion for indicating the WTRU's location, for example.

In an example, a WTRU may transmit the differential location information in one or more initial access messages. For example, the WTRU may transmit its location information in one or more Msg 1/Msg A, using a first RACH preamble associated with a reference location (e.g., area, zone, cell, TRP, PRU). The WTRU may transmit the differential location information, relative with respect to the reference location, using a second RACH preamble associated with the difference (e.g., difference in x and y coordinates, distance from reference location). In another example, the WTRU may transmit in the first transmission (e.g., Msg 1/Msg A) the identifier/index of a previously transmitted report of the location information and in the second transmission (e.g., in Msg 1/Msg 3/Msg A) the differential location information with respect to the location information transmitted previously.

In an example, the WTRU may send its location information in one or more RACH occasions or in a combination of one or more initial access messages (e.g., in Msg 1 and Msg 3). Such transmissions over multiple occasions/messages may be performed based on a preconfigured pattern, possibly associated with the area/zone where the WTRU may be located. For example, when a WTRU is located in a first area, the WTRU may send the location information via a first pattern (e.g., multiple transmissions of Msg 1/Msg A). Likewise, when the WTRU is located in a second area, the WTRU may use a second pattern (e.g., combination of Msg 1 and Msg 3), for example.

In another example, for security purposes, the WTRU may include certain distortion or truncation of its location information when transmitting via initial access messages. For example, the WTRU may reduce the granularity or resolution of its location information, such that a certain level of ambiguity may be artificially introduced in order to prevent locating the WTRU precisely. Such distortion/truncation may be performed while ensuring that any requirements associated with accuracy of WTRU location may still be met.

In an example, depending on the accuracy achievable when determining the WTRU location information, the WTRU may decide on whether and how to transmit the location information. For example, when the location information is determined with high accuracy (e.g., accuracy is above a threshold, or error is below a threshold), the WTRU may transmit the high accuracy location information in Msg 1 or Msg A, possibly after applying some encoding/encryption (e.g., encoding with private key and/or WTRU ID), by reducing the duration of the guard period, typically transmitted along with a RACH preamble. Such transmission may allow the WTRU to pre-compensate for the TA based on high accuracy location information of the WTRU, prior to receiving the TA value from the network. In another example, when the accuracy of the determined location information is low (e.g., accuracy is below a threshold, or error is above a threshold), the WTRU may decide not to transmit its location information during initial access.

In another example, the WTRU may perform one or more security operations (e.g., encoding, encryption, ciphering) when transmitting location information based on an authentication procedure (e.g., challenge and response authentication procedure) performed during initial access. For example, a WTRU may receive a private key from the network during a previous mode/session (e.g., when in RRC CONNECTED). When performing initial access, the WTRU may acquire via SIB the information on the security approach (e.g., ID of security algorithm) that may be applied for transmitting data with initial access messages. The WTRU may transmit in Msg 1/Msg A an explicit or implicit request for activating security when transmitting location information/data in Msg 3. For example, the WTRU may transmit in Msg 1/Msg A a RACH preamble associated with a request to transmit location information securely. The WTRU may also transmit, along with a RACH preamble, an indication/flag associated with the request, for example. In response, the WTRU may receive in Msg 2/Msg B a security challenge request message, possibly along with TC-RNTI, UL grant, and TA value. Upon reception of the security challenge request message the WTRU may perform calculation of a security response message based on the private key of the WTRU and/or security approach/algorithm (e.g., identified via SIB). The WTRU may then transmit in Msg 3 or Msg 5, the location information encrypted/ciphered with the calculated security challenge response, for example.

In an example, the WTRU may perform some security operations for encrypting/ciphering when transmitting the location information during initial access. For example, the WTRU may use one or more public keys and/or private keys (e.g., known to only WTRU and/or NW) for encrypting the messages containing location information. The public keys and private keys may be available to the WTRU via a combination of any of broadcast channels (e.g., SIB, SSB), via initial access messages (e.g., Msg 2, Msg 4, Msg B), via pre-configurations (e.g., from previous NAS/RRC connectivity with network during RRC CONNECTED state, or from LMF via previous LPP session), and via hardware based keys (e.g., SIM, IDs unique to WTRU hardware), for example. For example, when transmitting the location information in Msg 3, the WTRU may use a public key received from the base station (e.g., via SIB and/or Msg 1) and/or a private key generated/stored in the WTRU for encoding/encrypting the location information. The encoding/encryption of the location information may be performed by the WTRU at higher layers, e.g., Service Data Adaptation Protocol (SDAP), Packet Data Convergence Protocol (PDCP), MAC, or PHY (e.g., by scrambling the PUSCH containing the location information with the private and/or public keys), for example. For example, the WTRU may use the available/derived security keys (e.g., public key and/or private key) for scrambling the location information (e.g., in MAC CE, or PUSCH) or a differential/relative location information with the security keys when transmitting the information in Msg 1, Msg 3, Msg 5 or Msg A.

### WTRU Transmits its Location Information Securely Based on Authentication Procedure Performed During Initial Access

In one embodiment, a WTRU may determine its location information (e.g., with DL based positioning) and transmit the location information during initial access based on a preconfigured private key and a security mechanism (e.g., challenge and response authentication). An example procedure applied by the WTRU for transmitting location information securely is as follows:
The WTRU may receive one or more PRACH preambles and one or more private keys in an RRC message (e.g., RRC Release), possibly when transitioning from RRC CONNECTED to INACTIVE state
The WTRU may receive, in SIB, the assistance information for DL-based positioning (e.g., set of PRS configurations, TRP/cell IDs and location information of TRPs) and information on a security algorithm that may be applied for secure transmission of data in initial access messages (e.g., ID of security algorithm).
The WTRU may perform PRS measurements and determine WTRU location based on the assistance information and the measurements
The WTRU may transmit, in Msg 1/Msg A, a RACH preamble associated with a request to transmit location information securely
The WTRU may receive, in Msg 2/Msg B, a security challenge request, TC-RNTI, UL grant, and TA value
The WTRU may determine the security challenge response based on the stored private key and security algorithm
The WTRU may transmit, in Msg 3, the location information upon performing a security operation on the location information using the determined security challenge response. For example, the WTRU may perform an encryption/ciphering/scrambling operation on the location information using the security challenge response.
The WTRU may receive, in Msg4, the status of decoding of the WTRU location information at the network (e.g., the network may decrypt/decipher using the private key of the WTRU known at the network)
   If an ACK status indication is received (e.g., WTRU location decoded successfully), the WTRU may use the TC-RNTI as C-RNTI when sending subsequent RRC messages (e.g., in Msg 5)
   If a NACK status indication is received (e.g., WTRU location not decoded successfully) or Msg4 is not decodable, the WTRU may fall back to initiating the conventional (non-positioning) initial access procedure.

### 5 CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1-23. (canceled)

24. A wireless transmit/receive unit (WTRU) for wireless communication, the WTRU comprising:
a processor configured to:
receive configuration information indicating a first set of resources for initial access transmissions and a second set of resources for sounding reference signal for positioning (SRSp) transmissions;
transmit a first initial access transmission comprising a random access preamble associated with the first set of resources and first information indicating one or more resources from the second set of resources;
transmit a first SRSp transmission using the one or more resources from the second set of resources;
receive a second initial access transmission comprising second information indicating a first status for the first initial access transmission and a second status for the first SRSp transmission; and
transmit, based on the first status and the second status, an uplink transmission.

25. The WTRU of claim 24, wherein the first status is an acknowledgement (ACK) indication for the first initial access transmission and the second status is a negative ACK (NACK) indication for the first SRSp transmission, and wherein the uplink transmission comprises a second SRSp transmission using one or more resources indicated in the second information.

26. The WTRU of claim 24, wherein the first status is a negative acknowledgement (NACK) indication for the first initial access transmission and the second status is an acknowledgement (ACK) indication for the first SRSp transmission, and wherein the uplink transmission comprises a third initial access transmission.

27. The WTRU of claim 26, wherein the ACK indication for the first SRSp transmission indicates the one or more resources from the second set of resources.

28. The WTRU of claim 26, wherein the random access preamble is a first random access preamble, and wherein the third initial access transmission comprises the first random access preamble or a second random access preamble associated with the first set of resources, wherein the first random access preamble is different from the second random access preamble.

29. The WTRU of claim 24, wherein the configuration information is received via one of a broadcast communication or a system information block (SIB) message.

30. The WTRU of claim 24, wherein the first information comprises an identification of the one or more resources from the second set of resources for SRSp transmissions.

31. The WTRU of claim 24, wherein the second information further indicates an identification of the one or more resources associated with the first SRSp transmission.

32. A method for wireless communication, the method comprising:
receiving configuration information indicating a first set of resources for initial access transmissions and a second set of resources for sounding reference signal for positioning (SRSp) transmissions;
transmitting a first initial access transmission comprising a random access preamble associated with the first set of resources and first information indicating one or more resources from the second set of resources;
transmitting a first SRSp transmission using the one or more resources from the second set of resources;
receiving a second initial access transmission comprising second information indicating a first status for the first initial access transmission and a second status for the first SRSp transmission; and
transmitting, based on the first status and the second status, an uplink transmission.

33. The method of claim 32, wherein the first status is an acknowledgement (ACK) indication for the first initial access transmission and the second status is a negative ACK (NACK) indication for the first SRSp transmission, and wherein the uplink transmission comprises a second SRSp transmission using one or more resources indicated in the second information.

34. The method of claim 32, wherein the first status is a negative acknowledgement (NACK) indication for the first initial access transmission and the second status is an acknowledgement (ACK) indication for the first SRSp transmission, and wherein the uplink transmission comprises a third initial access transmission.

35. The method of claim 34, wherein the ACK indication for the first SRSp transmission indicates the one or more resources from the second set of resources.

36. The method of claim 34, wherein the random access preamble is a first random access preamble, and wherein the third initial access transmission comprises the first random access preamble or a second random access preamble associated with the first set of resources, wherein the first random access preamble is different from the second random access preamble.

37. The method of claim 32, wherein the configuration information is received via one of a broadcast communication or a system information block (SIB) message.

38. The method of claim 32, wherein the first information comprises an identification of the one or more resources from the second set of resources for SRSp transmissions.

39. The method of claim 32, wherein the second information further indicates an identification of the one or more resources associated with the first SRSp transmission.
